(19) United States
(12) Patent Application Publication
(10) Pub. No.: US 2024/0054361 A1
(43) Pub. Date: Feb. 15, 2024

(54) PROCESSING-CONDITION SEARCH DEVICE, NON-TRANSITORY COMPUTER-READABLE MEDIUM, AND PROCESSING-CONDITION SEARCH METHOD

(71) Applicant: Mitsubishi Electric Corporation, Tokyo (JP)

(72) Inventors: Atsuyoshi YANO, Tokyo (JP); Shoki MIYAGAWA, Tokyo (JP)

(73) Assignee: Mitsubishi Electric Corporation, Tokyo (JP)

(21) Appl. No.: 18/378,185

(22) Filed: Oct. 10, 2023

Related U.S. Application Data
(63) Continuation of application No. PCT/JP2021/016285, filed on Apr. 22, 2021.

(51) Int. Cl. G06N 5/022

(52) U.S. Cl. CPC G06N 5/022

(57) ABSTRACT

A process-condition search device includes: a parameter classifying unit that classifies a plurality of parameters into a plurality of variable parameters and one or more fixed parameters; a first dimensionality reducing unit that generates, from the variable parameters, first features whose dimension is equal to or smaller than a first dimension; a second dimensionality reducing unit that generates, from the one or more fixed parameters, a second feature whose dimension is equal to or smaller than a second dimension; a machine learning unit that generates a learning model by learning the relationship between the first features, the second features, and a plurality of evaluation values; a third dimensionality processing unit that generates a third feature whose dimension is equal to or smaller than the second dimension from one or more target fixed parameters, which are the one or more fixed parameters; an optimal-processing-condition search unit that uses the third feature and the learning model to search for an optimal value of features of the target variable parameters; and a dimension restoring unit that specifies a retrieved processing condition from the optimal value and the one or more target fixed parameters.

### CROSS REFERENCE TO RELATED APPLICATION

This application is a continuation application of International Application No. PCT/JP2021/016265 having an international filing date of Apr. 22, 2021.

### BACKGROUND OF THE INVENTION

### 1. Field of the Invention

The disclosure relates to a processing-condition search device, a non-transitory computer-readable medium, and a processing-condition search method.

### 2. Description of the Related Art

A processing machine for industrial use performs a predetermined processing on a workpiece or material to change its shape or state. Examples of such processing machines include machine tools that cut or grind materials and plant equipment that mixes, reacts, heats, cools, dries, or calcines materials.

Typically, such processing machines allow multiple parameters to be set to reflect the user's intention. Since the processing result of a processing machine depends on a processing condition, which is a combination of multiple parameters, it is necessary to set an appropriate processing condition for the processing machine to achieve a desired processing result.

However, when there are multiple parameters, and each parameter can be set with a continuous value or a stepwise discrete value, the number of combination patterns of the parameters is enormous. Therefore, a great deal of time and effort is required for carrying out a trial-and-error process to discover a processing condition that can achieve a desired processing result.

With respect to such parameters, conventionally, predicted values based on an evaluation value of a processing result and a processing condition corresponding to the evaluation value have been obtained to predict an evaluation value corresponding to a processing condition for processing that has not been performed, and an optimal processing condition have been calculated on the basis of the predicted value, but the higher the dimension of the parameter, the more difficult a global search of the optimal value becomes.

Accordingly, in Patent Literature 1, a method is proposed to extract a feature from high-dimensional data by means such as principal component analysis, and reduce the dimension of the extracted feature to make a problem easier to handle.
Patent Literature 1: Japanese Patent Application Publication (Translation of PCT Application) No. 201.2-509190 (paragraph 0014)

### SUMMARY OF THE INVENTION

However, with conventional dimensionality reduction, all parameters are search targets as a result of extracting a feature from all parameters, so there is a problem of not being able to apply the conventional dimensionality reduction to cases in which some parameters are not allowed to be changed due to the user's intention or the state of the processing site.

For example, if the processing results depend not only on control parameters but also on characteristic parameters related to the properties of the material, such as size or specific gravity, or environmental parameters related to the environment of the processing site, such as temperature and humidity, the search for an optimal processing condition must take these parameters into account as well. However, when dimensionality reduction is performed, these parameters that are unchangeable are also subject to change.

Accordingly, an object of one or more aspects of the present invention is to enable a global search of an optimal processing condition on parameters that are allowed to be changed, even when there are parameters that are not allowed to be changed for the processing condition used for the processing.

A processing-condition search device according to an aspect of the disclosure includes: processing circuitry to store processing-result evaluation information representing a plurality of processing conditions each having a plurality of parameters and a plurality of evaluation values of a plurality of processing results under the processing conditions; to classify the plurality of parameters into a plurality of variable parameters allowing change and one or more fixed parameters not allowing change; to generate one or more first features corresponding to the processing conditions by generating the first features with a dimension equal to or smaller than a first dimension from the variable parameters, the first dimension being a predetermined dimension; to generate one or more second features corresponding to the processing conditions by generating the second features with a dimension equal to or smaller than a second dimension from the one or more fixed parameters, the second dimension being a predetermined dimension; to generate a learning model by learning a relationship between the one or more first features, the one or more second features, and the evaluation values; to generate a third feature with a dimension equal to or smaller than the second dimension from one or more target fixed parameters, the one or more target fixed parameters being one or more fixed parameters used under a target processing condition, the target processing condition being a processing condition to be retrieved; to search for an optimal value of a feature of a plurality of target variable parameters by using the third feature and the learning model, the target variable parameters being a plurality of variable parameters used under the target processing condition; and to specify a retrieved processing condition from the optimal value and the one or more target fixed parameters, the retrieved processing condition being a processing condition retrieved as the target processing condition.

A non-transitory computer-readable medium that stores therein a program according to an aspect of the disclosure that causes a computer to execute processes of: storing processing-result evaluation information representing a plurality of processing conditions each having a plurality of parameters and a plurality of evaluation values of a plurality of processing results under the processing conditions; classifying the plurality of parameters into a plurality of variable parameters allowing change and one or more fixed parameters not allowing change; generating one or more first features corresponding to the processing conditions by generating the first features with a dimension equal to or smaller than a first dimension from the variable parameters, the first dimension being a predetermined dimension; generating one or more second features corresponding to the processing conditions by generating the second features with a dimension equal to or smaller than a second dimension from the one or more fixed parameters, the second dimension being a predetermined dimension; generating a learning model by learning a relationship between the one or more first features, the one or more second features, and the evaluation values; generating a third feature with a dimension equal to or smaller than the second dimension from one or more target fixed parameters, the one or more target fixed parameters being one or more fixed parameters used under a target processing condition, the target processing condition being a processing condition to be retrieved; searching for an optimal value of a feature of a plurality of target variable parameters by using the third feature and the learning model, the target variable parameters being a plurality of variable parameters used under the target processing condition; and specifying a retrieved processing condition from the optimal value and the one or more target fixed parameters, the retrieved processing condition being a processing condition retrieved as the target processing condition.

A processing-condition search method according to an aspect of the disclosure includes: classifying a plurality of parameters into a plurality of variable parameters allowing change and one or more fixed parameters not allowing change, the variable parameters being included in processing-result evaluation information representing a plurality of processing conditions each having the parameters and a plurality of evaluation values of a plurality of processing results under the processing conditions; generating one or more first features corresponding to the processing conditions by generating the first features with a dimension equal to or smaller than a first dimension from the variable parameters, the first dimension being a predetermined dimension; generating one or more second features corresponding to the processing conditions by generating the second features with a dimension equal to or smaller than a second dimension from the one or more fixed parameters, the second dimension being a predetermined dimension; generating a learning model by learning a relationship between the one or more first features, the one or more second features, and the evaluation values; generating a third feature from one or more target fixed parameters, the third feature having a dimension equal to or lower than the second dimension, the one of more target fixed parameters being one or more fixed parameters used under a target processing condition, the target processing condition being a processing condition to be retrieved; searching for an optimal value of features of a plurality of target variable parameters by using the third feature and the learning model, the target variable parameters being a plurality of variable parameters used under the target processing condition; and specifying a retrieved processing condition from the optimal value and the one or more target fixed parameters, the retrieved processing condition being a processing condition retrieved as the target processing condition.

According to one or more aspects of the present invention, a global search of an optimal processing condition is enabled on parameters that are allowed to be changed, even when there are parameters that are not allowed to be changed for the processing condition used for the processing.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a processing system according to first to sixth embodiments;

FIG. 2 is a block diagram schematically illustrating a configuration of a process-condition search device according to first to fourth embodiments;

FIG. 3 is a schematic diagram illustrating an example of processing-result evaluation information;

FIGS. 4A and 4B are schematic diagrams illustrating examples of parameter data representing parameters classified by a parameter classifying unit-r;

FIG. 5 is a block diagram illustrating a hardware configuration example of a process-condition search device;

FIG. 6 is a flowchart illustrating the operation of the processing system according to the first embodiment;

FIG. 7 is a schematic diagram for explaining a search method according to the first embodiment;

FIG. 8 is a block diagram schematically illustrating a configuration of a parameter classifying unit according to the second embodiment;

FIGS. 9A and 9B are schematic diagrams illustrating examples of low and high correlations between Qx and Rx;

FIG. 10 is a flowchart illustrating an example of a parameter classifying operation by a parameter classifying unit according to the second embodiment;

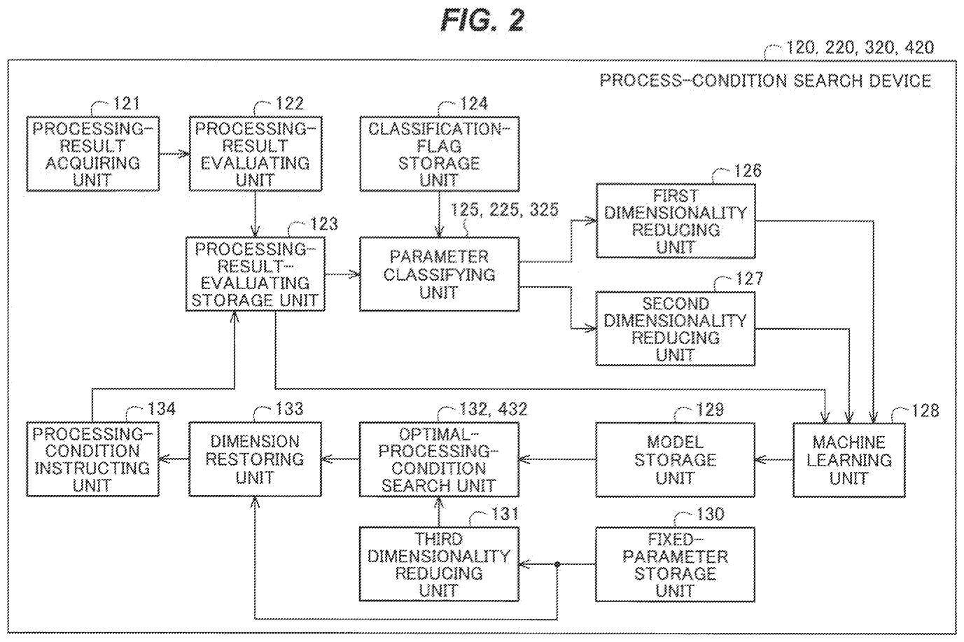

FIG. 2.1 is a block diagram schematically illustrating a configuration of a parameter classifying unit according to a third embodiment;

FIG. 12 is a flowchart illustrating an example of a parameter sorting operation by a parameter sorting unit according to the third embodiment;

FIG. 13 is a flowchart illustrating the operation of an optimal-processing-condition search unit according to a fourth embodiment during a first search;

FIG. 14 is a block diagram schematically illustrating a configuration of a processing-condition search device according to the fifth embodiment;

FIG. 15 is a flowchart illustrating the operations of a first dimensionality reducing unit, a second dimensionality reducing unit, a fourth dimensionality reducing unit, a first comparing unit, and a second comparing unit according to the fifth embodiment;

FIG. 16 is a block diagram schematically illustrating a configuration of a processing-condition search device according to the sixth embodiment; and

FIG. 17 is a flowchart illustrating the operations of a first dimensionality reducing unit, a second dimensionality reducing unit, a fourth dimensionality reducing unit, a combining unit, and a comparing unit according to the sixth embodiment.

### DETAILED DESCRIPTION OF THE INVENTION

### First Embodiment

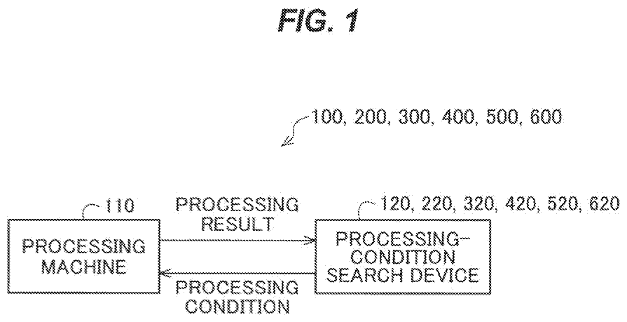

FIG. 1 is a block diagram schematically illustrating a configuration of a processing system 100 according to the first embodiment.

The processing system 100 includes a processing machine 110 and a processing-condition search device 120.

The processing machine 110 performs processing by using a processing condition from the processing-condition search device 120 and gives processing result information, which is information representing a processing result of the processing, to the processing-condition search device 120.

The processing-condition search device 120 receives the processing result information under the processing condition set in the processing machine 110 and searches for a processing condition suitable for the processing machine 110.

The processing condition consists of multiple parameters.

FIG. 2 is a block diagram schematically illustrating a configuration of the processing-condition search device 120.

The processing-condition search device 120 includes a processing-result acquiring unit 121, a processing-result evaluating unit 122, a processing-result-evaluation storage unit 123, a classification-flag storage unit 124, a parameter classifying unit 125, a first dimensionality reducing unit 126, a second dimensionality reducing unit 127, a machine learning unit 128, a model storage unit 129, a fixed-parameter storage unit 130, a third dimensionality reducing unit 131, an optimal-processing-condition search unit 132, a dimensionality restoring unit 133, and a processing-condition instructing unit 134.

The processing-result acquiring unit. 121 acquires processing result information, which is information representing a processing result, from the processing machine 110. The acquired processing result information is given to the processing-result evaluating unit 122.

The processing result information type differs depending on the type of the processing machine 110 or the purpose of the processing. For example, if the processing result information is inspection data on a workpiece, the inspection result value may be the error from a target value determined by the processing specification or the defect rate.

In the first embodiment, the processing-result acquiring unit 121 acquires processing result information from the processing machine 110, but the first embodiment is not limited to such an example. For example, the processing result information may be acquired from an inspection machine or the like separate from the processing machine 110. Alternatively, a user may input the processing result information via an input unit (not illustrated).

The processing-result evaluating unit 122 determines an evaluation value by evaluating the processing result that is a result of processing performed by the processing machine 110 and adds the determined evaluation value to processing-result evaluation information described later in association with a retrieved processing condition, which is a processing condition used when the processing was performed.

For example, the processing-result evaluating unit 122 evaluates the processing result represented by the processing result information from the processing-result acquiring unit 121 and determines its evaluation value.

The evaluation value is a numerical value such as a continuous or discrete value, a categorical value representing an attribute, a logical value representing the truth or falsity of a proposition, or the like.

Here, the evaluation value represents the quality of a processing result. For example, the evaluation value may be a numerical value that represents the quality of processing as a continuous or discrete value. A specific example is the defect rate, which represents the rate of processing defects as a continuous value from 0 to 1. In this case, a smaller value represents a better processing result.

Alternatively, the evaluation value may be a category representing the quality of the processing result or a logical value representing the truth or falsity of a predetermined proposition.

The processing-result evaluating unit 122 then stores the evaluation value in the processing-result-evaluation storage unit 123 in association with the corresponding processing condition.

The processing-result-evaluation storage unit 123 stores multiple processing conditions and processing-result evaluation information representing multiple evaluation values of multiple processing results under the multiple processing conditions. As mentioned above, each of the processing conditions includes multiple parameters.

For example, the processing-result evaluation information stores a default processing condition that is different from the processing conditions searched by the processing-condition search device 120 in association with the evaluation value of the processing result under the default processing condition. Such information should be input via an input unit (not illustrated).

The processing-result evaluation information stores a processing condition instructed by the processing-condition instructing unit 134 to the processing machine 110, in association with an evaluation value determined by the processing-result evaluating unit 122 for a processing result under the processing condition.

It is assumed that the processing-result evaluation information for all processes performed via the processing-condition search device 120 is stored in the processing-result-evaluation storage unit 123.

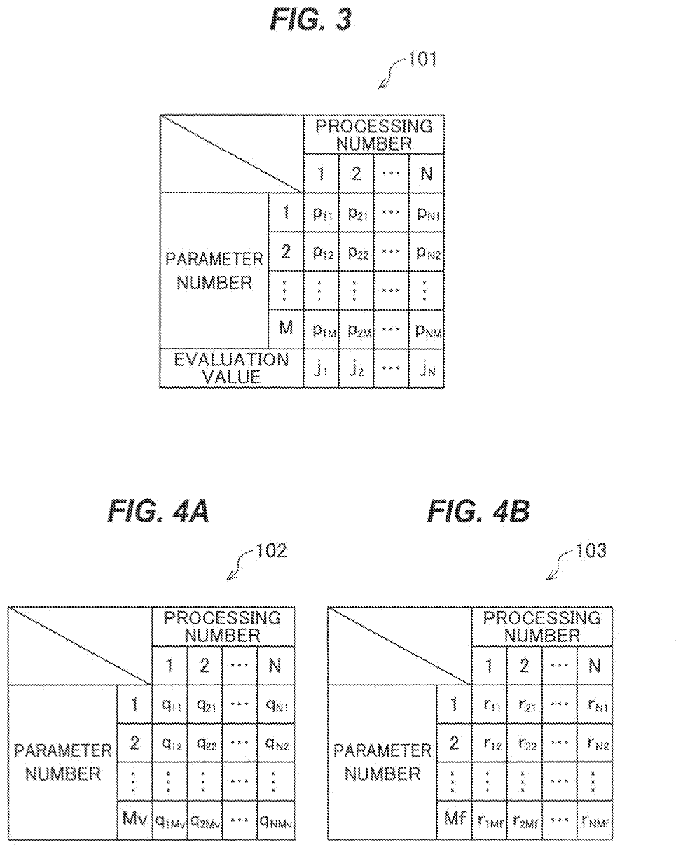

FIG. 3 is a schematic diagram illustrating an example of processing-result evaluation information.

As illustrated in FIG. 3, processing-result evaluation information 101 is a matrix of various parameters constituting processing conditions and corresponding evaluation values.

In the example illustrated in FIG. 3, a processing number, which is processing identification information for identifying each process, is assigned to each of the processes executed N times (where N is an integer greater than or equal to one) in the past. For each processing number, M types (where M is an integer greater than or equal to two) of parameters used for processing and the corresponding evaluation values are arranged vertically in the matrix.

When a new process is executed, a new column is added to the right end of the matrix, and processing conditions and their evaluation values are recorded in the column.

Specific examples of parameters include control parameters of the processing machine 110, material parameters representing the properties of the material, such as types or property values, and environmental parameters such as temperature and humidity at the processing site. These parameters include numerical values such as continuous or discrete values, categorical values representing attributes, and logical values representing the truth or falsity of propositions.

For classification of multiple parameters, the classification-flag storage unit 124 stores classification flags indicating, for each parameter type, whether a parameter is a variable parameter or a fixed parameter.

For example, the classification-flag storage unit 124 stores classification flags indicating, for each parameter type of the parameters constituting a processing condition, whether a parameter is a changeable variable parameter or an unchangeable fixed parameter. In other words, a variable parameter is a parameter that is allowed to be changed, and a fixed parameter is a parameter that is not allowed to be changed.

A classification flag may be set in response to an instruction by a user via an input unit (not illustrated). A classification flag may also be automatically set on the basis of conditions such as the type or model of the processing machine 110. A classification flag may also be received from other devices via a communication unit (not illustrated).

Fixed parameters include control parameters of the processing machine 110 that are unchangeable or that a user does not wish to change, parameters related to the material, such as parameters of the property, size, or quantity of the material, or environmental parameters, such as parameters of air pressure or temperature and humidity in the processing environment.

The parameter classifying unit 125 classifies multiple parameters included in the processing-result evaluation information into multiple variable parameters that permit change and one or more fixed parameters that do not permit change. Here, the parameter classifying unit 125 classifies the multiple parameters into multiple variable parameters and one or more fixed parameters by referring to the classification flags.

For example, the parameter classifying unit 125 reads the multiple parameters included in the processing-result evaluation information stored in the processing-result-evaluation storage unit 123 and the classification flags stored in the classification-flag storage unit 124. The parameter classifying unit 125 classifies the parameters into variable parameters or fixed parameters in accordance with the classification flags. The parameter classifying unit 125 then generates variable parameter data representing the classified variable parameters and fixed parameter data representing the sorted fixed parameters.

FIGS. 4A and 4B are schematic diagrams illustrating examples of parameter data representing parameters classified by the parameter classifying unit 125.

FIG. 4A is an example of variable parameter data 102 storing variable parameters, and FIG. 4B is an example of fixed parameter data 103 storing fixed parameters.

The variable parameter data 102 stores Mv types of parameters, and the fixed parameter data 103 stores Mf types of parameters.

The variable parameter data 102 and the fixed parameter data 103 each consist of a matrix in which parameters are stored for each processing number of the processes executed N times in the past, as in the processing-result evaluation information 101 illustrated in FIG. 3. Mv and Mf correspond to the dimension numbers of the variable parameters and the fixed parameters, respectively.

In the variable parameter data 102, q_{xy} denotes the y-th variable parameter of the processing number x. In the fixed parameter data 103, r_{xz} denotes the z-th fixed parameter of the processing number z. These are extracted from the processing number x column under the processing condition stored in the processing-result evaluation information 101 illustrated in FIG. 3.

Referring back to FIG. 2, the first dimensionality reducing unit 126 is a first dimensionality processing unit that generates a first feature of a dimension equal to or smaller than a predetermined dimension or a first dimension from the variable parameters included in the variable parameter data, to generate one or more first features corresponding to the processing conditions. Here, the first dimensionality reducing unit 126 generates the first features by reducing the dimension of the variable parameters when the dimension of the variable parameters is larger than the first dimension.

For example, the first dimensionality reducing unit 126 analyzes the variable parameter data generated by the parameter classifying unit 125 and determines whether or not the dimension number Mv of the variable parameter data is larger than a predetermined threshold THv. When the dimension number Mv is larger than the threshold THv, the first dimensionality reducing unit 126 executes a first dimensionality reduction process, which is a dimensionality reduction process to convert the variable parameter data into first feature data expressed in a dimension number Lv equal to or smaller than the threshold THv. Here, the threshold THv corresponds to a first dimension. When the dimension number Lv is two or more, the first features of multiple dimensions included in the first feature data is also referred to as “a first feature set.”

Specifically, when the element of the x-th dimension of the first feature data corresponding to the processing number n is avₙₓ, avₙₓ is a function of variable parameters qₙ₁, qₐ₂, . . . , g_{nMv} and is expressed by the following equation (1):

avₙₓ=fx(qₐ₁,qₐ₂, . . . ,qₙₐᵥ) (1)
where fx is a function that converts a variable parameter into an element of the x-th dimension of the first feature data. The element here is a first feature.

As the dimensionality reduction process, for example, principal component analysis may be used. In this case, each principal component obtained through principal component analysis is a feature. The dimension can be reduced by extracting first to k-th principal components in descending order of eigenvalues of a covariance matrix and removing the remaining principal components. Here, k<Mv.

An autoencoder using a neural network is also a preferable example of dimensionality reduction processing. In this case, the output of the encoder network of the autoencoder is a feature. Here, the encoder network refers to a subnetwork that involves encoder processing and is part of the neural network constituting the autoencoder.

A technique known as “black box optimization” is a technique in which a predicted value of an evaluation value corresponding to a processing condition under which processing has not been executed is predicted on the basis of an evaluation value of a processing result and the processing condition corresponding to the evaluation value, and on the basis of the predicted value, an optimal processing condition is calculated. Some known dimensionality reduction processes in Bayesian optimization, which is a type of black box optimization, includes Random EMbedding Bayesian Optimization (REMBO), which uses a random matrix to embed a low-dimensional space into a high-dimensional space, and Line Bayesian Optimization (LINEBO), which restricts a search space to a one-dimensional space, and these processes can also be used as the dimensionality reduction process in the first embodiment.

REMBO is described in detail in Reference 1 below, and LINEBO is described in detail in Reference 2 below.
Reference 1: Wang, Ziyu, et al. “Bayesian optimization in high dimensions via random embeddings.” Twenty-Third International Joint Conference on Artificial Intelligence. 2013.
Reference 2: Kirschner, Johannes, et al. “Adaptive and Safe Bayesian Optimization in High Dimensions via One-Dimensional Subspaces.” arXiv preprint arXiv: 1902.03229 (2019)

Other dimensionality reduction processes may include multidimensional scaling, independent component analysis, non-negative matrix factor analysis (NMF), local linear embedding (LLE), locality preserving projection (LPP), Laplacian eigenmap (LEP), kernel principal component analysis, Karhunen-Loeve expansion, and t-distributed Stochastic Neighbor Embedding (t-SNE).

When the dimension number Mv of the variable parameter data is equal to or smaller than the threshold THv, the first dimensionality reducing unit 126 does not perform the dimensionality reduction and uses the variable parameter data as the first feature data.

The first dimensionality reducing unit 126 then gives the first feature data to the machine learning unit 128.

The second dimensionality reducing unit 127 is a second dimensionality processing unit that generates a second feature of a dimension equal to or smaller than a predetermined dimension or a second dimension from the one or more fixed parameters represented by the fixed parameter data, to generate one or more second features corresponding to the processing conditions. Here, the second dimensionality reducing unit 127 generates the second features by reducing the dimension of the fixed parameters when the dimension of the fixed parameters is larger than the second dimension.

For example, the second dimensionality reducing unit 127 analyzes the fixed parameter data generated by the parameter classifying unit 125 and determines whether or not the dimension number Mf of the fixed parameter data is larger than a predetermined threshold THf. When the dimension number Mf is larger than the threshold THf, the second dimensionality reducing unit 127 executes a second dimensionality reduction process, which is a dimensionality reduction process to convert the fixed parameter data into second feature data expressed in a dimension number Lf equal to or smaller than the threshold THf. The specific process of dimensionality reduction is the same as that by the first dimensionality reducing unit 126. Here, the dimension number Mf corresponds to a second dimension. When the dimension number Lf is two or more, the second features of multiple dimensions included in the second feature data is also referred to as “a second feature set.”

When the element of the x-th dimension of the second feature data corresponding to the fixed parameter at the processing number n is afₙₓ, afₙₓ is a function of fixed parameter values rₙ₁, rₙ₂, . . . , r_{aMf} and is expressed by the following equation (2):

afₙₓ=hx(rₙ₁,rₙ₂, . . . ,r_{nMf}) (2)
where hx is a function that converts the fixed parameter into an element of the x-th dimension of the second feature data. The element here is a second feature.

When the dimension number Mf of the fixed parameter data is equal to or smaller than the threshold THf, the second dimensionality reducing unit 127 does not perform the dimensionality reduction and uses the fixed parameter data as the second feature data.

The second dimensionality reducing unit 127 then gives the second feature data to the machine learning unit 128.

Since the fixed parameters are not search targets of the optimal-processing-condition search unit 132 described later, even when the dimension number Mf of the fixed parameter data is large, the second dimensionality reduction process may be omitted, and the fixed parameter data may be used as the second feature data.

The machine learning unit 128 learns the relationship between one or more first features, one or more second features, and multiple evaluation values to generate a learning model.

For example, the machine learning unit 128 deems the first feature data received from the first dimensionality reducing unit 126 and the second feature data received from the second dimensionality reducing unit 127 as input values and the evaluation values included in the processing-result evaluation information stored in the processing-result-evaluation storage unit 123 as response values, learns the relationship between the input values and the response values, and generates a learning model that expresses the relationship by a mathematical model.

The learning model can be, for example, a regression model if the evaluation values are numerical values, such as continuous values or discrete values, or a classification model if the evaluation values are categorical values or logical values. When new input values, that is, respective feature values, are provided and input to the learning model, predicted values can be calculated for the evaluation values of the processing results corresponding to the new input values. Specific examples of learning algorithms for generating such a learning model include linear regression, nonlinear regression, regression trees, model trees, support vector regression, gene programming, Gaussian process regression, linear discriminant analysis, logistic regression, k-neighborhood methods, support vector machines, decision trees, random forests, and neural networks.

The model storage unit 129 stores the learning model generated by the machine learning unit 128.

The fixed-parameter storage unit 130 stores the one or more fixed parameters used under a target processing condition, which is a processing condition to be searched for. The one or more fixed parameters stored in the fixed-parameter storage unit 130 are also referred to as “one or more target fixed parameters.” Data representing the one or more fixed parameters stored in the fixed-parameter storage unit 130 is also referred to as “fixed parameter data” or “target fixed parameter data.”

For example, the fixed parameters stored in the fixed-parameter storage unit 130 may be set in response to a user's instruction, set automatically under a specific condition, or input from another device through a communication means (not illustrated).

The classification flags stored in the classification-flag storage unit 124 or the fixed parameters stored in the fixed-parameter storage unit 130 may be changed after the search procedure described later is carried out.

The third dimensionality reducing unit 131 is a third dimensionality processing unit that generates a third feature of a dimension equal to or smaller than the second dimension from one or more fixed parameters stored in the fixed-parameter storage unit 130. Here, the third dimensionality reducing unit 131 generates the third features by reducing the dimension of the fixed parameters when the dimension of the fixed parameters is larger than the second dimension.

For example, the third dimensionality reducing unit 131 analyzes the fixed parameter data stored in the fixed-parameter storage unit 130 and determines whether or not the dimension number Mf of the fixed parameter data is larger than the threshold THf. When the dimension number Mf is larger than the threshold THf, the third dimensionality reducing unit 131 executes a third dimensionality reduction process, which is dimensionality reduction process to convert the fixed parameter data into third feature data expressed in a dimension number Lf equal to or smaller than the dimension number Mf. The third dimensionality reduction process is the same as the second dimensionality reduction process performed by the second dimensionality reducing unit 127. The third feature data is given to the optimal-processing-condition search unit 132. When the dimension number Lf is two or more, the third features included in the third feature data is also referred to as “a third feature set.”

If the second dimensionality reduction process is principal component analysis, the third dimensionality reducing unit 133 may use the eigenvalues and eigenvectors used in the process to extract the same number of principal components as that of the second feature data.

If the second dimensionality reduction process uses an autoencoder, the third dimensionality reducing unit 131 may input fixed parameters into the same encoder network of the second dimensionality reducing unit. 127 and use the output as the third features.

If the dimension number Mf of the fixed parameter data is equal to or smaller than the predetermined threshold THf, the third dimensionality reducing unit 131 does not perform the third dimensionality reduction process and directly gives the fixed parameter data read from the fixed-parameter storage unit 130 to the optimal-processing-condition search unit 132 as the third feature data.

The optimal-processing-condition search unit 132 is a search unit that uses the third features and the learning model to search for an optimal value of the features of multiple target variable parameters, which are variable parameters used under a target processing condition.

For example, the optimal-processing-condition search unit 132 uses the learning model stored in the model storage unit 129 to search for the optimal processing condition. At this time, the optimal-processing-condition search unit 132 gives the third feature data received from the third dimensionality reducing unit 131 and the candidates of the features of the variable parameters generated through a predetermined method as input to the learning model and acquires prediction values of an evaluation value obtained as a response of the learning model. The optimal-processing-condition search unit 132 then gives the candidate that returns the best prediction value to the dimensionality restoring unit 133 as an optimal processing condition. The candidate included in the optimal processing condition corresponds to the optimal value.

The dimensionality restoring unit 133 is a specifying unit that specifies a retrieved processing condition, which is a processing condition searched for as a target processing condition, on the basis of the optimal value and the one or more target fixed parameters. Here, when the dimension of the variable parameters is larger than the first dimension, the dimensionality restoring unit 133 restores parameters from the optimal value so that the parameters are of the same dimension as the dimension of the variable parameters.

For example, when the dimension number Mv of the variable parameter data is larger than the threshold THv, the dimensionality restoring unit 133 converts the optimal processing condition received from the optimal-processing-condition search unit 132 into variable parameters. For example, if the variable parameter value of the x-th dimension after the conversion is qₓ*, and the element of the y-th dimension of the feature of the variable parameters output as the optimal processing condition is av_{y}*, qₓ* is a function of av₁*, av₂*, . . . , av_{Lv}*and is expressed by the following equation (3):

qₓ*=g(av₁*,av₂*, . . . ,av_{Lv}*) (3)

Here, g is a function that converts a feature into a variable parameter. For example, if the dimensional compression process is principal component analysis, the dimensionality restoring unit 133 can convert the optimal processing condition into variable parameters by using the eigenvalues and eigenvectors used in the dimensional compression process.

If the dimensional compression process is an autoencoder, the dimensionality restoring unit 133 can input a feature to a decoder network and obtain a variable parameter as output. Here, the decoder network refers to a subnetwork that involves decoder processing and is part of the neural network constituting the autoencoder.

When the dimension number Mv of the variable parameter data is smaller than the threshold THv, the dimensionality restoring unit 133 does not perform dimensionality restoration and directly uses the optimal processing condition received from the optimal-processing-condition search unit 132 as variable parameters.

The processing-condition instructing unit 134 gives the retrieved processing condition to the processing machine 110 to cause the processing machine 110 to perform processing under the retrieved processing condition and adds the retrieved processing condition to the processing-result evaluation information.

For example, the processing-condition instructing unit 134 sets a processing condition by combining the variable parameters received from the dimensionality restoring unit 133 with the fixed parameters read from the fixed-parameter storage unit 130 and instructs the processing machine 110 to perform processing under this processing condition. The processing-condition instructing unit 134 stores this processing condition in the processing-result evaluation information stored in the processing-result-evaluation storage unit 123.

At this time, a user may be able to freely modify the processing condition through an input unit (not illustrated). In such a case, the processing condition modified by a user is output from the processing-condition instructing unit 134 to the processing machine 110 and the processing-result-evaluation storage unit 123.

As described above, when the processing machine 110 receives a processing condition from the processing-condition search device 120, the processing machine 110 performs processing in accordance with the processing condition. The processing machine 110 then gives processing result information representing the result of the processing to the processing-condition search device 120.

The hardware configuration of the processing-condition search device 120 is described below.

The processing-result acquiring unit 121, the processing-result evaluating unit 122, the parameter classifying unit 125, the first dimensionality reducing unit 126, the second dimensionality reducing unit 127, the machine learning unit 128, the third dimensionality reducing unit 131, the optimal-processing-condition search unit 132, the dimensionality restoring unit 133, and the processing-condition instructing unit 134, all illustrated in FIG. 2, can each be implemented by processing circuitry.

The processing circuitry may be a circuit including a processor or dedicated hardware. These components may be implemented in a distributed computing environment configured by connecting the components on a computer network such as a cloud. In other words, the processing-condition search device 120 may be implemented by a computer.

The processing-result-evaluation storage unit 123, the classification-flag storage unit 124, the model storage unit 129, and the fixed-parameter storage unit 130 can be implemented by a storage device.

The storage device is a semiconductor memory such as a dynamic random access memory (DRAM), a static random access memory (SRAM), or a flash memory, a recording medium such as a magnetic disk, an optical disk, or a magnetic tape, or a data storage on a computer network.

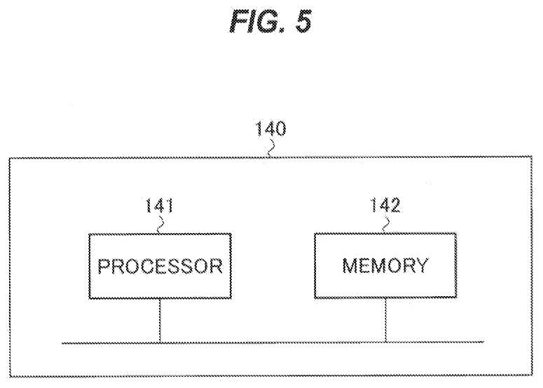

FIG. 5 is a block diagram illustrating a hardware configuration example of the processing-condition search device 120.

The processing circuitry 140 described above includes, for example, a processor 141 and a memory 142.

When the components of the processing-condition search device 120 are implemented by the processing circuitry 140, the processor 141 reads and executes the programs stored in the memory 142 to implement the processing-result acquiring unit 121, the processing-result evaluating unit 122, the parameter classifying unit 125, the first dimensionality reducing unit 126, the second dimensionality reducing unit 127, the machine learning unit 128, the third dimensionality reducing unit 131, the optimal-processing-condition search unit 132, the dimensionality restoring unit 133, and the processing-condition instructing unit 134.

In other words, when the components of the processing-condition search device 120 are implemented by the processing circuitry 140, the processing-result acquiring unit 121, the processing-result evaluating unit 122, the parameter classifying unit 125, the first dimensionality reducing unit 126, the second dimensionality reducing unit 127, the machine learning unit 128, the third dimensionality reducing unit 131, the optimal-processing-condition search unit 132, the dimensionality restoring unit 133, and the processing-condition instructing unit 134 are implemented by programs or software.

Such programs may be provided via a network or may be recorded and provided on a recording medium (non-transitory computer-readable medium). That is, such programs may be provided as, for example, program products.

The processing-result-evaluation storage unit 123, the classification-flag storage unit 124, the model. storage unit 129, and the fixed-parameter storage unit 330 are implemented by the memory 142.

The memory 142 is also used as a work area for the processor 141.

The processor 141 is a central processing unit (CPU) or the like. The memory 142 is, for example, a nonvolatile or volatile semiconductor memory such as a random access memory (RAM), a read only memory (ROM), a flash memory, or a magnetic disk.

When the processing circuitry implementing the processing-result acquiring unit 121, the processing-result evaluating unit 122, the parameter classifying unit 125, the first dimensionality reducing unit 126, the second dimensionality reducing unit 127, the machine learning unit 128, the third dimensionality reducing unit 131, the optimal-processing-condition search unit 132, the dimensionality restoring unit 133, and the processing-condition instructing unit 134 is dedicated hardware, the processing circuitry is, for example, a field programmable gate array (FPGA) or an application specific integrated circuit (ASIC).

Each of the components of the processing-condition search device 120 may be implemented by a combination of a processing circuit including a processor and dedicated hardware. Alternatively, the processing-condition search device 120 may be implemented by connecting multiple processing circuits including processors as described above or multiple pieces of dedicated hardware by a computer network such as a cloud.

In other words, the components of the processing-condition search device 120 can be implemented by circuitry.

The operation of the processing system 100 according to the first embodiment is now explained.

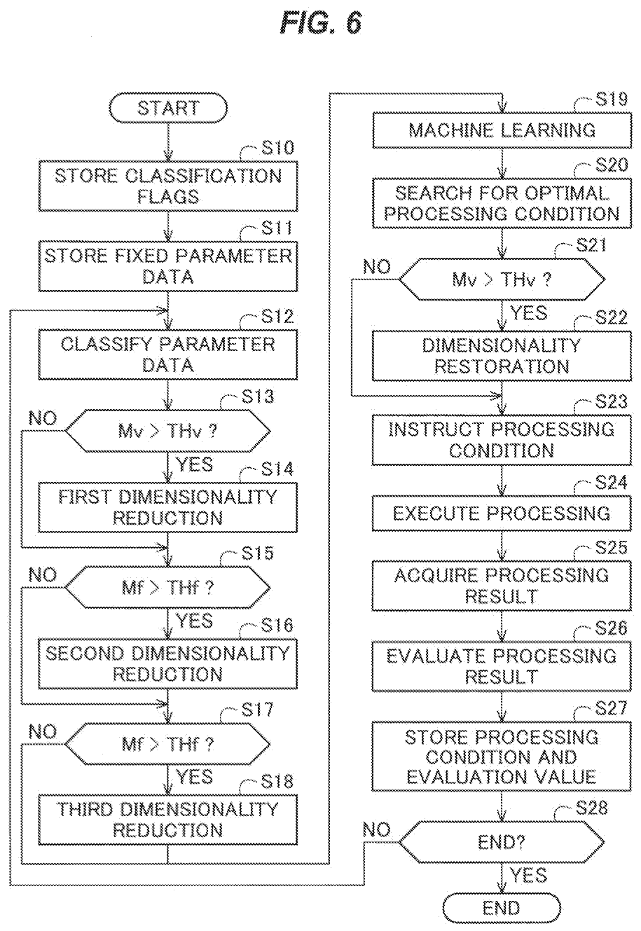

FIG. 6 is a flowchart illustrating the operation of the processing system 100 according to the first embodiment.

First, the classification-flag storage unit 124 stores classification flags (step S10). Here, for example, a user of the processing system 100 may use an input unit (not illustrated) to set whether the parameters used in the processing machine 11.0 are variable parameters or fixed parameters for each parameter type and store the classification flags in accordance with the settings.

Next, the fixed-parameter storage unit 130 stores the values of the parameters that are designated as unchangeable fixed parameters by the classification flags stored in step S10 as fixed parameter data (step S11). The fixed parameter data may also be set, for example, in response to a user's instruction via an input unit (not illustrated).

Next, the parameter classifying unit 125 reads multiple parameters from the processing-result-evaluation storage unit 123 and refers to the classification flags stored in the classification-flag storage unit 124 to classify each of the parameters into a variable parameter or a fixed parameter (step S12). The parameter classifying unit 125 then generates variable parameter data representing the classified variable parameters and fixed parameter data representing the classified fixed parameters, gives the variable parameter data to the first dimensionality reducing unit 126, and gives the fixed parameter data to the second dimensionality reducing unit 127.

The first dimensionality reducing unit 126 analyzes the variable parameter data generated by the parameter classifying unit 125 and determines whether or not the dimension number Mv of the variable parameter data is larger than a threshold THv (step S13). If the dimension number Mv is larger than the threshold THv (Yes in step S13), the process proceeds to step S14, and if the dimension number Mv is equal to or smaller than the threshold THv (No in step S13), the process proceeds to step S315. If the dimension number Mv is equal to or smaller than the threshold THv (No in step S13), the first dimensionality reducing unit 126 does not perform dimensionality reduction and directly gives the variable parameter data to the machine learning unit 128 as first feature data.

In step S14, the first dimensionality reducing unit 126 converts the variable parameter data into first feature data expressed in a dimension number Lv smaller than the threshold THv.

In step S15, the second dimensionality reducing unit 127 analyzes the fixed parameter data classified by the parameter classifying unit 125 and determines whether or not the dimension number Mf of the fixed parameter data is larger than a threshold THf. If the dimension number Mf is larger than the threshold THf (Yes in step S15), the process proceeds to step S16, and if the dimension number Mf is equal to or smaller than the threshold THf (No in step S15), the process proceeds to step S17. If the dimension number Mf is equal to or smaller than the threshold THL (No in step S15), the second dimensionality reducing unit 127 does not perform dimensionality reduction and directly gives the fixed parameter data to the machine learning unit 128 as second feature data.

In step S16, the second dimensionality reducing unit 127 converts the fixed parameter data into second feature data expressed in a dimension number Lf smaller than the threshold THf.

In step S17, the third dimensionality reducing unit 131 determines whether or not the dimension number Mf of the fixed parameter data stored in the fixed-parameter storage unit 130 is larger than the threshold THf. If the dimension number Mf is larger than the threshold THf (Yes in step S17), the process proceeds to step S18, and if the dimension number Mf is equal to or smaller than the threshold THf (No in step S17), the process proceeds to step S19. If the dimension number Mf is equal to or smaller than the threshold THf (No in step S17), the third dimensionality reducing unit 131 does not perform dimensionality reduction and directly gives the fixed parameter data to the optimal-processing-condition search unit 132 as third feature data.

In step S18, the third dimensionality reducing unit 131 reads the fixed parameter data from the fixed-parameter storage unit 130, performs a dimensionality reduction process that is the same as that by the second dimensionality reducing unit 127 on the fixed parameter data to convert the fixed parameter data to third feature data, and gives the third feature data to the optimal-processing-condition search unit 132.

In step S19, the machine learning unit 128 reads the first feature data received from the first dimensionality reducing unit 126, the second feature data received from the second dimensionality reducing unit 127, and the multiple evaluation values included in the processing-result evaluation information stored in the processing-result-evaluation storage unit 123, deems the respective features as input values and the evaluation value as a response value to learn the relationship between the input values and the evaluation value, and generates a learning model that expresses the relationship by a mathematical model. The generated learning model is stored in the model storage unit 129.

Next, the optimal-processing-condition search unit 132 uses the learning model stored in the model storage unit 129 to search for an optimal processing condition (step S20). At this time, the optimal-processing-condition search unit 132 gives the third feature data received from the third dimensionality reducing unit 131 and the candidates of the features of the variable parameters generated through a predetermined method as input values to the learning model, acquires a prediction value of an evaluation value obtained as a response of the learning model, and uses the candidate that gives the best prediction value as the optimal processing condition.

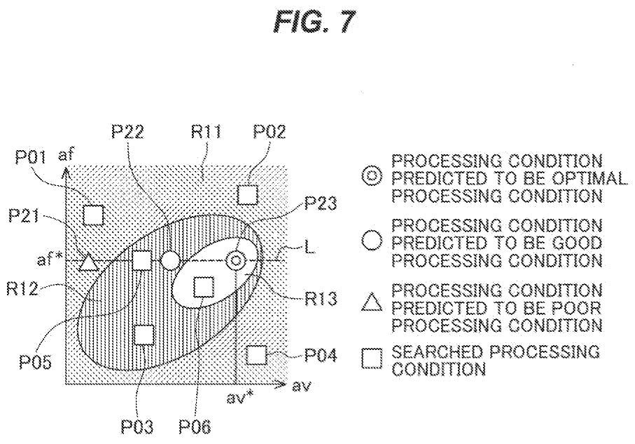

FIG. 7 is a schematic diagram for explaining a search method according to the first embodiment.

FIG. 7 illustrates a graph in which the horizontal axis is a feature av of a variable parameter and the vertical axis is a feature af of a fixed parameter, as an example of a case in which an evaluation value is determined by the feature av of the variable parameter and the feature af of the fixed parameter.

In FIG. 7, the square points P01 to P06 represent retrieved processing conditions stored in the processing-result-evaluation storage unit 123.

Regions R11, R12, and R13 represent regions respectively predicted to have poor, good, and the best processing results on the basis of a learning model based on the data of the retrieved processing conditions learned and generated by the machine learning unit 128. Here, the evaluation value is, for example, a defect rate. The evaluation value is defined as a continuous value from 0% to 1.00%, with a defect rate of less than 1% as the best, less than 5% as good, and 5% or more as poor. Therefore, a predicted value of an evaluation value in the region R11 is 5% or more, a predicted value of an evaluation value in the region R12 is 1% or more and less than 5%, and a predicted value of an evaluation value in the region R13 is less than 1%.

It should be noted that these regions are not obvious and can only be observed by inputting feature values av of variable parameters and feature values af of fixed parameters corresponding to the respective coordinates to the learning model and obtaining corresponding predicted values.

Now, if a third feature is a feature value af′ of a fixed parameter, the search space is on the dashed line L illustrated in FIG. 7. The dimension number of the search space is equal to the dimension number of the features of the variable parameters, in other words, the first features. In this example, the features of the variable parameters is one-dimensional to simplify the drawing, but for two-dimensional or higher-dimensional features, the search space is also two-dimensional or higher-dimensional.

Search candidates are selected from points in the search space limited in this way by the third features, and any means may be used as the selection method. For example, the search space may be divided into a grid with predetermined intervals, like in a grid search, and each grid point may be used as a search candidate, or a predetermined number of arbitrary points in the search space may be randomly selected, like in a random search. Alternatively, sequential optimization methods such as mountain climbing, annealing, particle swarm optimization, or Bayesian optimization may be used to select candidate points one by one while their predicted values are obtained, and then determine the next candidate point on the basis of this result.

On the dashed line L, the triangular point P21, the circular point P22, and the double circle point P23 represent search candidates selected through a predetermined method, and the horizontal axis coordinate of each point is a candidate feature of a variable parameter.

Now it is assumed that the predicted defect rate of a first search candidate corresponding to the triangular point P21 is 5% or higher, e.g., 12%. It is assumed that the predicted defect rate of a second search candidate corresponding to the circular point P22 is 1% or higher and less than 5%, e.g., 3%. It is assumed that the predicted defect rate of a third search candidate corresponding to the double circle point P23 is 1% or less, e.g., 0.2%. At this time, the optimal-processing-condition search unit 132 determines the third search candidate indicated by the point P23 is the best candidate and gives the feature av* of the variable parameter of the candidate to the dimensionality restoring unit 133 as an optimal processing condition.

If the learning model generated by the machine learning unit 128 is a Gaussian process regression model, the optimal-processing-condition search unit 132 can use this model to calculate not only a predicted value of the evaluation value but also its confidence interval. The optimal-processing-condition search unit 132 then can use an acquisition function calculated on the basis of the calculated confidence interval to calculate a score representing whether or not any unsearched point should be searched. In such a case, the optimal-processing-condition search unit 132 may use the feature of a variable parameter at a search point where the score calculated with the acquisition function is the largest, as the optimal processing condition.

As described above, the optimal-processing-condition search unit 132 selects the optimal candidate only for the feature of a variable parameter while the feature of the fixed parameters is retained and uses the optimal candidate as an optimal processing condition, so that it is possible to search only for the variable parameters without a change in the fixed parameters. Since the optimal-processing-condition search unit 132 selects the candidate predicted to achieve the best result by the learning model as the optimal processing condition, the number of actual trials conducted by the processing machine 110 is reduced, and an efficient processing condition search can be possible.

Referring back to FIG. 6, the dimensionality restoring unit 133 determines whether or not the dimension number Mv of the variable parameter data is larger than the threshold THv (step S21). If the dimension number Mv of the variable parameter data is larger than the threshold THv (Yes in step S21), the process proceeds to step S22, and if the dimension number Mv of the variable parameter data is equal to or smaller than the threshold THv (No in step S21), the process proceeds to step S23.

In step S22, the dimensionality restoring unit 133 converts the optimal processing condition received from the optimal-processing-condition search unit 132 into variable parameters. The dimensionality restoring unit 133 then gives a processing condition that combines the variable parameters and the fixed parameters read from the fixed-parameter storage unit 130 to the processing-condition instructing unit 134 as the retrieved processing condition.

In the case of No in step S21, the dimensionality restoring unit 133 does not perform dimensionality restoration, directly uses the optimal processing condition received from the optimal-processing-condition search unit 132 as the variable parameters, and gives the processing condition combining the variable parameters and the fixed parameters read from the fixed-parameter storage unit 130 to the processing-condition instructing unit 134 as the retrieved processing condition.

Next, the processing-condition instructing unit 134 instructs the processing machine 110 to perform processing under the processing condition received from the dimensionality restoring unit 133 (step S23). The processing-condition instructing unit 134 adds this processing condition to the processing-result evaluation information stored in the processing-result-evaluation storage unit 123.

At this time, a user may be able to freely modify the processing condition through an input unit (not illustrated). In this case, the processing condition modified by a user is given from the processing-condition instructing unit 134 to the processing machine 110 and the processing-result-evaluation storage unit 123.

Next, the processing machine 110 executes processing in accordance with the processing condition received from the processing-condition instructing unit 134 (step S24).

The processing-result acquiring unit 121 then acquires the processing result information from the processing machine 110 (step S25).

The processing-result evaluating unit 122 determines an evaluation value of the processing result on the basis of the processing result information acquired by the processing-result acquiring unit 121 (step S26).

The processing-result evaluating unit 122 then stores the evaluation value in the processing-result evaluation information stored in the processing-result-evaluation storage unit 123 in association with the processing condition added by the processing-condition instructing unit 134.

The parameter classifying unit 125 then determines whether or not to end the process (step S28). If the process is not to be ended (No in step S28), the process returns to step S12, and the above-described process is repeated. Whether or not to end the process may be determined through any method. For example, an upper limit may be set for the number of repetitions, or a user may instruct the end by viewing the processing result. Moreover, the processing-condition search device 120 may end the search according to a certain criterium.

As described above, according to the first embodiment, since the processing condition is divided into fixed parameters and variable parameters, the fixed parameters and variable parameters are each subjected to dimensionality reduction and converted to features, and the features of the variable parameters is searched for an optimal processing condition while the features of the fixed parameters are retained, even if the parameters constituting the processing conditions are of high dimensions and some of them are unchangeable parameters, an optimal value can be retrieved efficiently only from the changeable parameters.

According to the first embodiment, the optimal processing condition is retrieved from low-dimensional features of the variable parameters, which are obtained through dimensionality reduction of the variable parameters and thus are of a dimension lower than that of the variable parameters; therefore, even when the variable parameters are high-dimensional, the search space is low-dimensional, and the search of the optimal processing condition is easy.

According to the first embodiment, machine learning and searching of the optimal processing condition are performed on the basis of the lower-dimensional features obtained through dimensionality reduction; therefore, even when the parameters constituting the processing condition are high-dimensional, the computational power or memory capacity required for these processes can be reduced.

According to the first embodiment, since the candidate predicted to achieve the best result is selected by the learning model as the optimal processing condition, actual trials by the processing machine 110 can be reduced, and an efficient processing condition search can be possible.

According to the first embodiment, in machine learning for learning the relationship between processing conditions and evaluation values, a learning model is created by performing machine learning by using not only the variable parameter features, which are search targets of the optimal processing condition, but also the fixed parameter features so that the evaluation values of the processing results can be predicted by also taking the fixed parameters into account, and thereby prediction accuracy can be improved.

### Second Embodiment

In the first embodiment, variable parameters and fixed parameters are classified in accordance with classification flags. However, among parameters that are classified into variable parameters in accordance with classification flags, there some parameters 'that are highly correlated with fixed parameters and thus can be sorted into fixed parameters. In the second embodiment, such parameters are automatically identified and sorted into fixed parameters.

As illustrated in FIG. 1, a processing system 200 according to the second embodiment includes a processing machine 110 and a processing-condition search device 220.

The processing machine 110 of the processing system 200 according to the second embodiment is the same as the processing machine 110 of the processing system 100 according to the first embodiment.

As illustrated in FIG. 2, the processing-condition search device 220 according to the second embodiment includes a processing-result acquiring unit 121, a processing-result evaluating unit 122, a processing-result-evaluation storage unit 123, a classification-flag storage unit 124, a parameter classifying unit 225, a first dimensionality reducing unit 126, a second dimensionality reducing unit 127, a machine learning unit 128, a model storage unit 129, a fixed-parameter storage unit 130, a third dimensionality reducing unit 131, an optimal-processing-condition search unit 132, a dimensionality restoring unit 133, and a processing-condition instructing unit 134.

The processing-result acquiring unit 121, the processing-result evaluating unit 122, the processing-result-evaluation storage unit 123, the classification-flag storage unit 124, the first dimensionality reducing unit 126, the second dimensionality reducing unit 127, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 220 according to the second embodiment are respectively the same as the processing-result acquiring unit 121, the processing-result evaluating unit 122, the processing-result-evaluation storage unit 123, the classification-flag storage unit 124, the first dimensionality reducing unit 126, the second dimensionality reducing unit 127, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 120 according to the first embodiment.

The parameter classifying unit 225 classifies each of the parameters included in the processing-result evaluation information stored in the processing-result-evaluation storage unit 123 into a variable parameter or a fixed parameter and generates variable parameter data representing the classified variable parameters and fixed parameter data representing the classified fixed parameters.

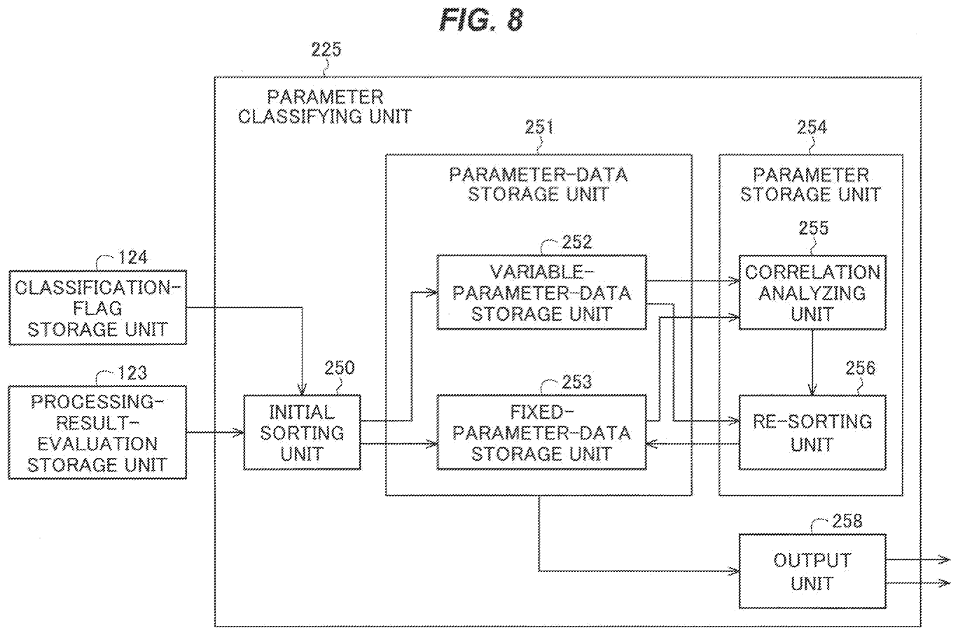

FIG. 8 is a block diagram schematically illustrating a configuration of the parameter classifying unit 225 according to the second embodiment.

The parameter classifying unit 225 includes an initial sorting unit 250, a parameter-data storage unit. 251, a parameter sorting unit 254, and an output unit 258.

The initial sorting unit 250 refers to classification flags to sort the parameters to multiple variable parameters and one or more fixed parameters. Here, the parameters sorted into variable parameters by the initial sorting unit 250 are also referred to as initial variable parameters, and the parameters sorted into fixed parameters by the initial sorting unit 250 are also referred to as initial fixed parameters.

For example, the initial sorting unit 250 sorts each of the parameters included in the processing-result evaluation information stored in the processing-result-evaluation storage unit 123 into a fixed parameter or a variable parameter as an initial state in accordance with a classification flag read from the classification-flag storage unit 124, and generates variable parameter data representing the sorted variable parameters and fixed parameter data representing the sorted fixed parameters.

The initial sorting unit 250 then stores the variable parameter data and the fixed parameter data in the parameter-data storage unit 251.

The parameter-data storage unit 251 includes a variable-parameter-data storage unit 252 that stores the variable parameter data generated by the initial sorting unit 250 and a fixed-parameter-data storage unit 253 that stores the fixed parameter data generated by the initial sorting unit 250.

The parameter sorting unit 254 finally sorts the variable parameters and the fixed parameters sorted in an initial state by the initial sorting unit 250.

The parameter sorting unit 254 includes a correlation analyzing unit 255 and a re-sorting unit 256.

The correlation analyzing unit 255 specifies multiple combinations of the initial variable parameters and the one or more initial fixed parameters and analyzes the correlation of each of the combinations.

For example, the correlation analyzing unit 255 combines the variable parameter data stored in the variable-parameter-data storage unit 252 and the fixed parameter data stored in the fixed-parameter-data storage unit 253 for each parameter type and analyzes the correlation between the parameters.

Specifically, it is assumed that Mv types of variable parameter data 102 are stored in the variable-parameter-data storage unit 252 for the past N times of processes, as illustrated in FIG. 4A, and Mf types of fixed parameter data 103 are stored in the fixed-parameter-data storage unit 253, as illustrated in FIG. 4B. In this case, a correlation score φ_{xy} expressed by the following equation (4) is calculated for all combinations of x and y.

φ_{xy}=Φ(Qx,Ry) (4)

Here, 1<x<Mv and 1<y<Mf, where Qx is a vector whose elements are the variable parameter values q₁ₓ, q₂ₓ, . . . , gₙₓ of the past N times of the parameter number x in the variable parameter data 102, and Ry is a vector whose elements are the fixed parameter values r_{1y}, r_{2y}, . . . , r_{NY} of the past N times of the parameter number y in the fixed parameter data 103.

The function Φ outputs a numerical value representing the correlation between vectors. Specific examples of the correlation score φ_{xy} are an absolute value of a correlation coefficient, cross entropy, Kullback-Leibler (KL) divergence, or other mutual information.

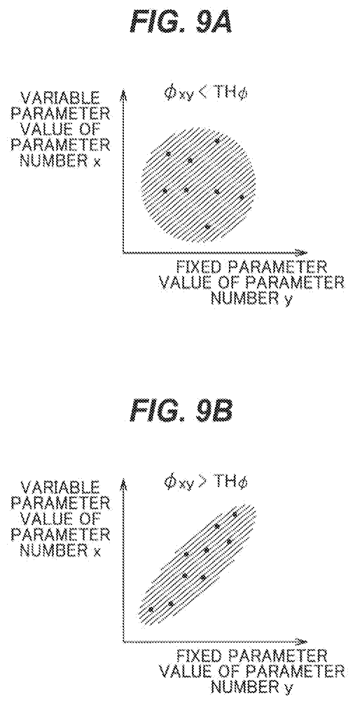

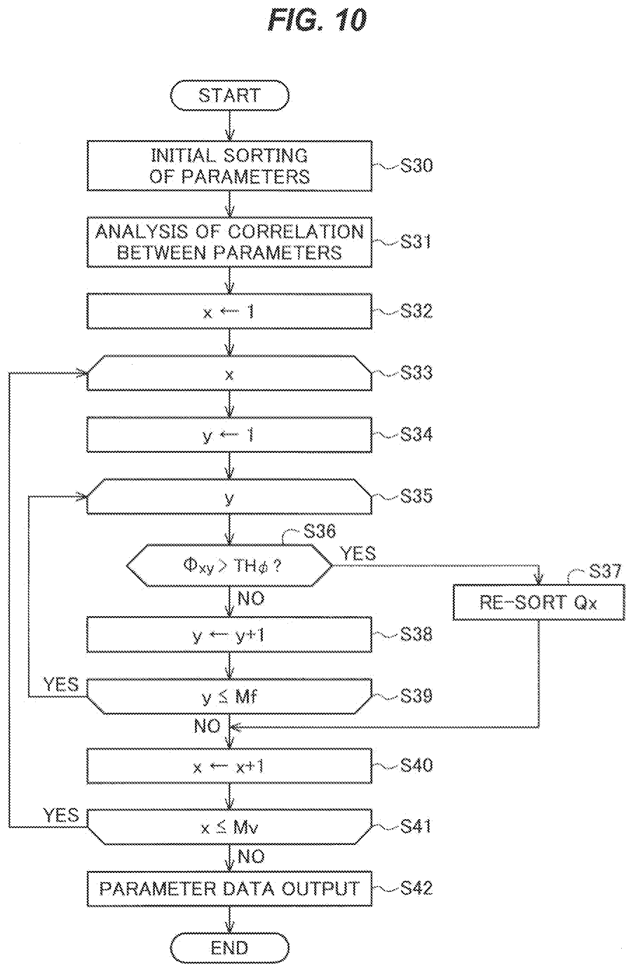

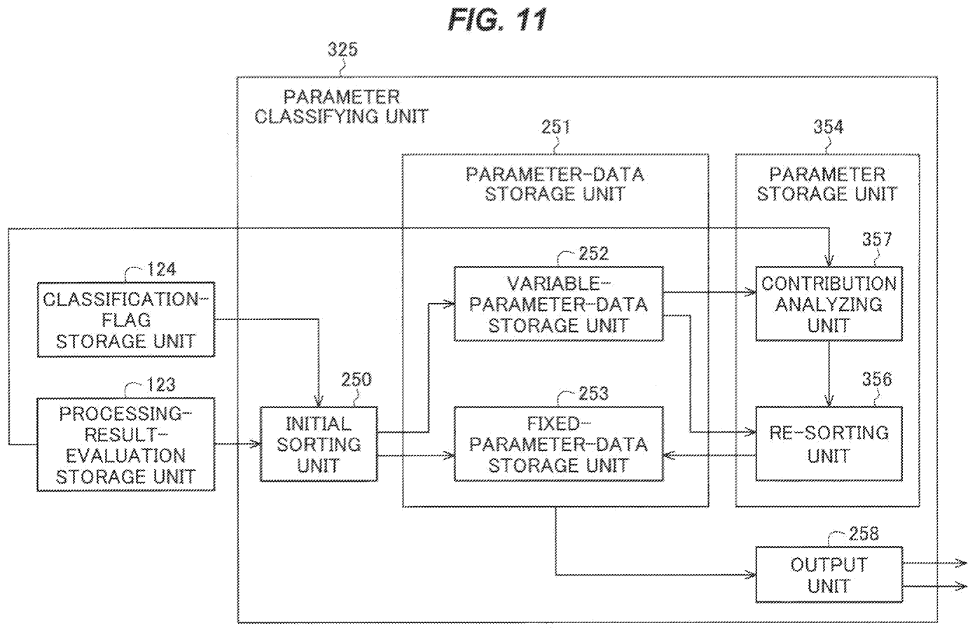

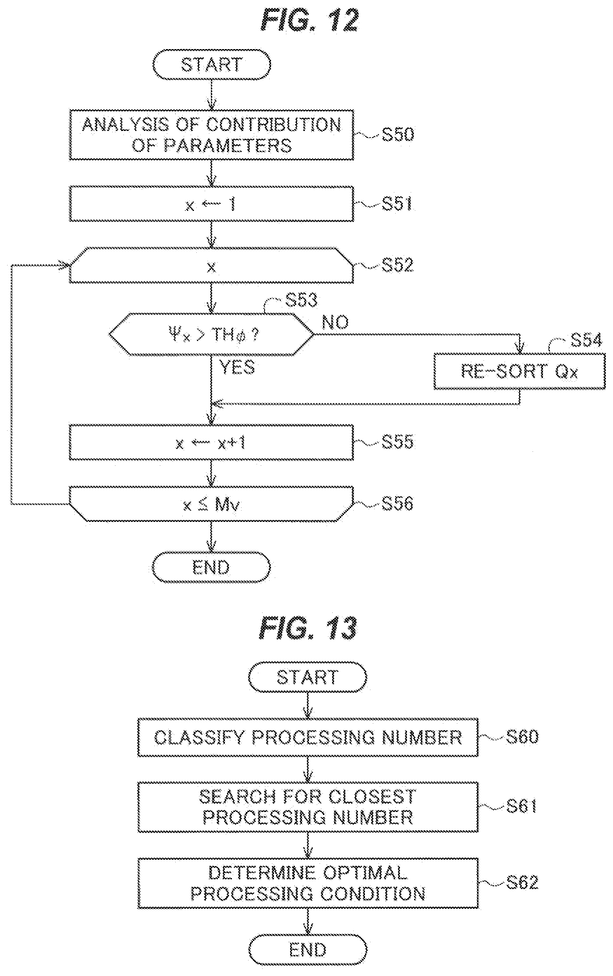

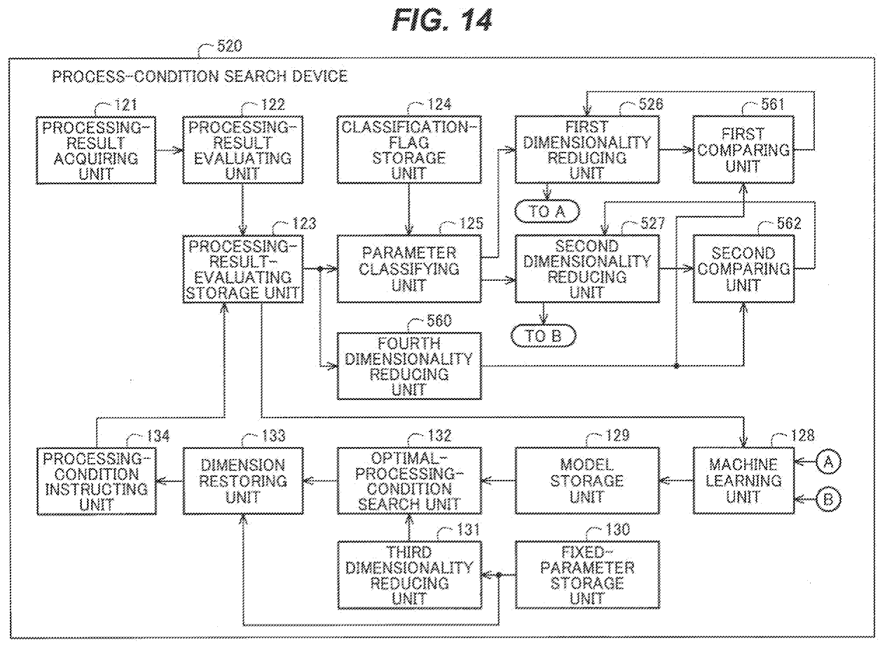

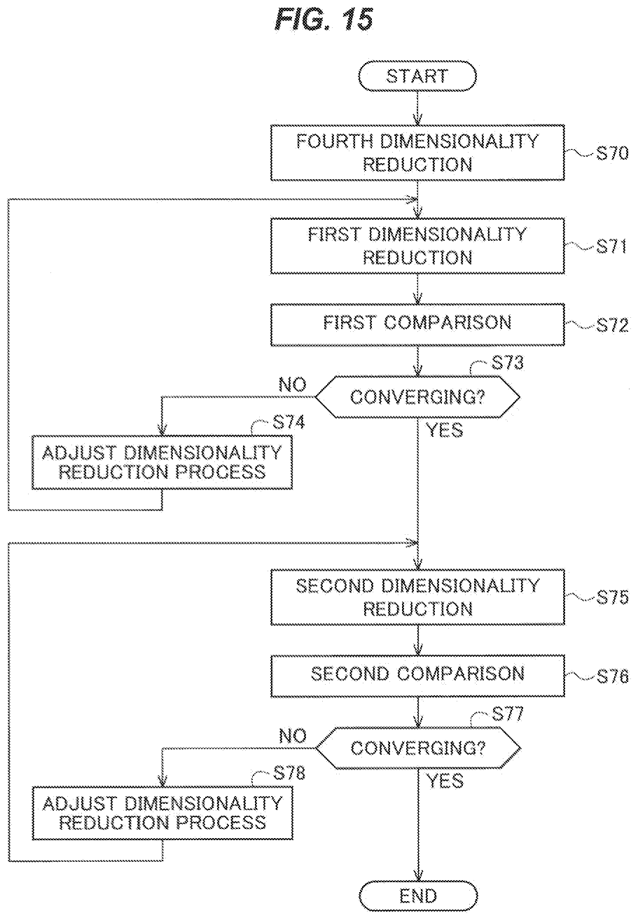

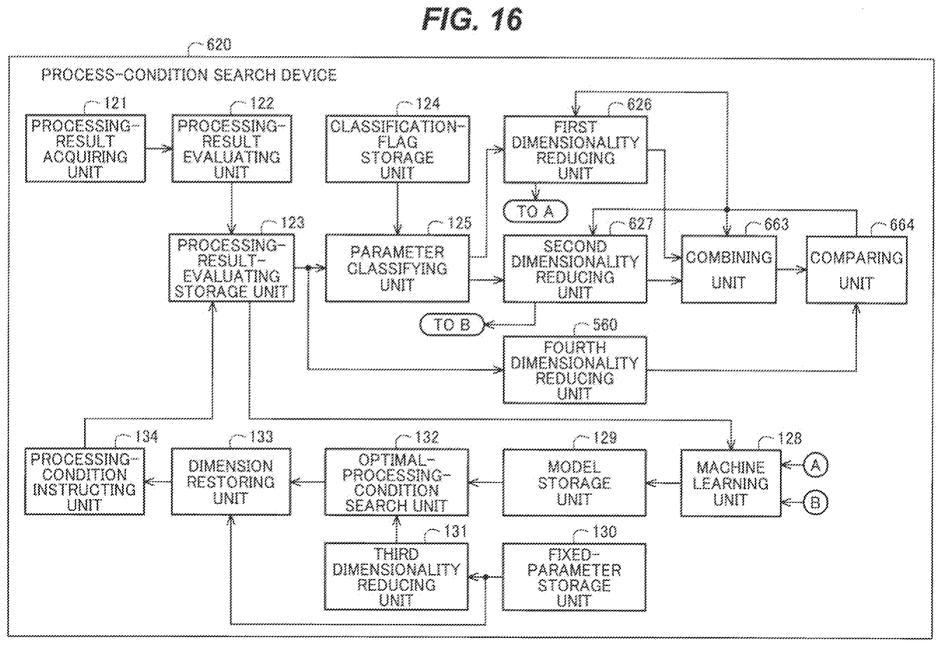

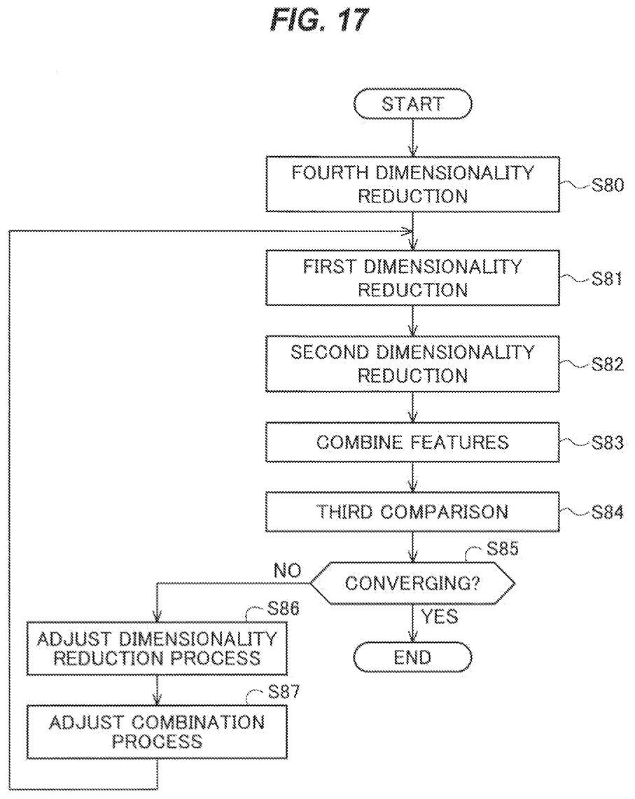

FIGS. 9A and 9B illustrate examples of low and high correlations between Qx and Rx.

FIG. 9A illustrates a low correlation between Qx and Rx, and FIG. 9B illustrates a high correlation between Qx and Rx.

In the graphs illustrated in FIGS. 9A and B, the vertical axis represents a variable parameter of a parameter number x, and the horizontal axis represents a fixed parameter of parameter number y.

As illustrated in FIG. 9A, when the correlation is low, the variable parameters and the fixed parameters are distributed mostly without correlation, whereas, as illustrated in FIG. 9B, when the correlation is high, a certain relationship is observed between the variable parameters and the fixed parameters. In other words, in the latter case, the variable parameters can be regarded as being linked to the fixed parameters. Also, in the latter case, the variable parameters can be regarded as parameters whose values are determined automatically when the fixed parameters are determined. Thus, such variable parameters can be included in the fixed parameters. This is also the same for inverse correlations.

Accordingly, the re-sorting unit 256 re-sorts the variable parameter data on the basis of the correlation score calculated by the correlation analyzing unit 255. Specifically, the re-sorting unit 256 sorts the variable parameters that satisfy φₓᵥ>TH_{φ} on the basis of a predetermined threshold THφ to the fixed parameters and stores such variable parameters in the fixed parameter data.

In other words, the re-sorting unit 256 re-sorts the initial variable parameters that are included in combinations of the initial variable parameters and the one or more initial fixed parameters whose correlation is higher than a predetermined threshold, to the initial fixed parameters, and determines the re-sorted initial variable parameters as variable parameters and the re-sorted one or more initial fixed parameters as one or more fixed parameters.

After the re-sorting by the re-sorting unit 256 is completed, the output unit 256 gives the variable parameter data stored in the parameter-data storage unit 251 to the first dimensionality reducing unit 126 and the fixed parameter data to the second dimensionality reducing unit 127.

WIG. 10 is a flowchart illustrating an example of a parameter classification operation by the parameter classifying unit 225 according to the second embodiment.

First, the initial sorting unit 250 sorts the multiple parameters included in the processing-result evaluation information stored in the classification-flag storage unit 124 in initial sorting, to generate variable parameter data and fixed parameter data (step S30). The generated variable parameter data is stored in the variable-parameter-data storage unit 252, and the generated fixed parameter data is stored in the fixed-parameter-data storage unit 253.

Next, the correlation analyzing unit 255 combines the variable parameter data stored in the variable-parameter-data storage unit 252 and the fixed parameter data stored in the fixed-parameter-data storage unit 253 for each parameter type and analyzes the correlation between the parameters (step S31). Here, a correlation score φ_{xy} is calculated.

Next, the re-sorting unit 256 initializes the parameter number x for identifying a variable parameter to “1” (step S32).

The re-sorting unit 256 then repeats the following process until the parameter number x exceeds the maximum value Mv (step S33).

The re-sorting unit 256 initializes the parameter number y for identifying a fixed parameter to “1” (step S34).

The re-sorting unit 256 then repeats the following process until the parameter number y exceeds the maximum value Mf (step S35).

The re-sorting unit 256 determines whether or not the correlation score φ_{xy} calculated by the correlation analyzing unit 255 exceeds a predetermined threshold TH_{φ} (step S36). If the correlation score V_{xy} exceeds the threshold THv (Yes in step S36), the process proceeds to step S37, and if the correlation score φ_{xy} is equal to or smaller than the threshold THφ (No in step S36), the process proceeds to step S38.

In step S37, the re-sorting unit 256 re-sorts the variable parameter Qx of the parameter number x as a fixed parameter when the correlation score φ_{xy} is determined to have exceeded the threshold THφ. Specifically, the re-sorting unit 256 extracts the variable parameter Qx from the variable-parameter-data storage unit 252 and adds it to the fixed parameter data stored in the fixed-parameter-data storage unit 253.

In step S38, the re-sorting unit 256 adds “1” to the parameter number y.

The re-sorting unit 256 then determines whether or not the parameter number y is equal to or smaller than the maximum value Mf (step S39). If the parameter number y is equal to or smaller than the maximum value Mf (Yes in step S39), the process returns to step S35, and if the parameter number y exceeds the maximum value Mf (No in step S39), the process proceeds to step S40.

In step S40, the re-sorting unit 256 adds “1” to the parameter number x.

The re-sorting unit 256 then determines whether or not the parameter number x is equal to or smaller than the maximum value Mv (step S41). If the parameter number x is equal to or smaller than the maximum value Mv (Yes in step S41), the process returns to step S33, and if the parameter number x exceeds the maximum value Mv (No in step S41), the process proceeds to step S42.

In step S42, the output unit 258 outputs the variable parameter data and the fixed parameter data stored in the parameter-data storage unit 251.

As described above, according to the second embodiment, parameters that are once identified as variable parameters in accordance with the classification flags are re-sorted to fixed parameters if they are determined to have high correlation with fixed parameters as a result of analysis of their correlation with fixed parameters. This can further reduce the dimension of variable parameters, and thus for an optimal processing condition search is easy.

### Third Embodiment

In the second embodiment, parameters that are identified as variable parameters in accordance with the classification flags are re-sorted to fixed parameters if they are determined to have high correlation with fixed parameters. In the third embodiment, the contribution of parameters that are identified as variable parameters in accordance with the classification flags to a processing result is analyzed, and variable parameters that determined to not contribute are sorts into fixed parameters.

As illustrated in FIG. 1, a processing system 300 according to the third embodiment includes a processing machine 110 and a processing-condition search device 320.

The processing machine 110 of the processing system 300 according to the third embodiment is the same as the processing machine 110 of the processing system 100 according to the first embodiment.

As illustrated in FIG. 2, the processing-condition search device 320 according to the third embodiment includes a processing-result acquiring unit 121, a processing-result evaluating unit 122, a processing-result-evaluation storage unit 123, a classification-flag storage unit 124, a parameter classifying unit 325, a first dimensionality reducing unit 126, a second dimensionality reducing unit 127, a machine learning unit 128, a model storage unit 129, a fixed-parameter storage unit 130, a third dimensionality reducing unit 131, an optimal-processing-condition search unit 132, a dimensionality restoring unit. 133, and a processing-condition instructing unit 134.

The processing-result acquiring unit 121, the processing-result evaluating unit 122, the processing-result-evaluation storage unit 123, the classification-flag storage unit 124, the first dimensionality reducing unit 326, the second dimensionality reducing unit 127, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 320 according to the third embodiment are respectively the same as the processing-result acquiring unit 121, the processing-result evaluating unit 122, the processing-result-evaluation storage unit 123, the classification-flag storage unit 124, the first dimensionality reducing unit 126, the second dimensionality reducing unit 127, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 120 according to the first embodiment.

The parameter classifying unit 325 classifies each of the multiple parameters included in the processing-result evaluation information stored in the processing-result-evaluation storage unit 123 into a variable parameter or a fixed parameter and generates variable parameter data representing the classified variable parameters and fixed parameter data representing the classified fixed parameters.

FIG. 11 is a block diagram schematically illustrating a configuration of the parameter classifying unit 325 according to the third embodiment.

The parameter classifying unit 325 includes an initial sorting unit 250, a parameter-data storage unit 251, a parameter sorting unit 354, and an output unit 258.

The initial sorting unit 250, the parameter-data storage unit 251, and the output unit 258 of the parameter classifying unit 325 according to the third embodiment are respectively the same as the initial sorting unit 250, the parameter-data storage unit 251, and the output unit 258 of the parameter classifying unit 225 according to the second embodiment.

The parameter sorting unit 354 finally sorts the variable parameters and the fixed parameters sorted in initial state by the initial sorting unit 250.

The parameter sorting unit 354 includes a re-sorting unit 356 and a contribution analyzing unit 357.

The contribution analyzing unit 357 analyzes the contribution of each of the initial variable parameters to a corresponding evaluation value.

For example, the contribution analyzing unit 357 reads the variable parameter data from the variable-parameter-data storage unit 252 and reads the evaluation values corresponding to the respective variable parameters included in the variable parameter data from the processing-result-evaluation storage unit 123. The contribution analyzing unit 357 then analyzes the contribution of each of the variable parameters to the evaluation value.

Specifically, it is assumed that Mv types of variable parameter data 102 are stored in the variable-parameter-data storage unit 252 for the past N times of processes, as illustrated in FIG. 4A. It is also assumed that the evaluation values of the past N times of processes are stored in the processing-result-evaluation storage unit 123.

In this case, a contribution score ψₓ expressed by the following equation (5) is calculated for everyx satisfying 1<<x<Mv.

ψₓ=Ψ(Qx,J) (5)

Here, Qx is a vector whose elements are variable parameter values q₁ₓ, q₂ₓ, . . . , q_{Nx} of the past N times of the parameter number x included in the variable parameter data 102.

J is a vector whose elements are evaluation values j₁, j₂, . . . , j_{N} of the past N times.

The function ψ(Qx, J) calculates a contribution score that numerically expresses the contribution of Qx to J.

Specific examples of the contribution score ψₓ are an absolute value of the correlation coefficient between Qx and J.

Alternatively, the contribution score ψₓ may be the inverse of the magnitude of the regression error when J is subjected to simple regression analysis at Qx

Furthermore, the contribution score ψₓ may be the magnitude of the regression error in a multiple regression analysis of J with all variable parameters except Qx, i.e., all Qi satisfying i≠x.

The regression analysis of these includes linear regression, as well as, nonlinear regression and kernel regression.

The contribution score calculated in this way expresses whether or not the variable parameter of the parameter number x contributes to the evaluation value, and if the contribution is low, it can be considered that the effect of the variable parameter to the processing condition is small, and thus, the variable parameter can be excluded from the search range of the optimal processing condition.

If the contribution scores ψₓ of the variable parameters stored in the variable-parameter-data storage unit 252 are equal to or smaller than a predetermined threshold THψ, the re-sorting unit 356 sorts the parameters to fixed parameters.

In other words, the re-sorting unit 356 re-sorts the initial variable parameters whose contribution is equal to or smaller than a predetermined threshold to initial fixed parameters, to determine the sorted initial variable parameters as variable parameters and determine the one or more sorted initial fixed parameters as one or more fixed parameters.

FIG. 12 is a flowchart illustrating an example of a parameter sorting operation by the parameter sorting unit 354 according to the third embodiment.

First, the contribution analyzing unit 357 reads the variable parameter data from the variable-parameter-data storage unit 252 and reads the evaluation values corresponding to the respective variable parameters included in the variable parameter data from the processing-result-evaluation storage unit 123, The contribution analyzing unit 357 then analyzes the contribution of the variable parameters of each parameter type to the evaluation values (step S50). Specifically, the contribution analyzing unit. 357 calculates a contribution score ψₓ for all variable parameters of the parameter numbers x from the above equation (5).

Next, the re-sorting unit 356 initializes the parameter number x for identifying a variable parameter to “1” (step S51).

The re-sorting unit 356 then repeats the following process until the parameter number x exceeds the maximum value Mv (step S52).

The re-sorting unit 356 determines whether or not the contribution score ψₓ of the variable parameter corresponding to the parameter number x is larger than the threshold THψ (step S53). If the contribution score ψₓ is equal to or smaller than the threshold THψ (No in step 353), the process proceeds to step S54, and if the contribution score ψₓ is larger than the threshold THψ (Yes in step S53), the process proceeds to step S55.

In step S54, the re-sorting unit 356 re-sorts the variable parameter Qx of the parameter number x as a fixed parameter when the contribution score ψₓ is determined to be larger than the threshold THψ. Specifically, the re-sorting unit 356 extracts the variable parameter Qx from the variable-parameter-data storage unit 252 and adds it to the fixed parameter data stored in the fixed-parameter-data storage unit 253. The process then proceeds to step S55.

In step S55, the re-sorting unit 356 adds “1” to the parameter number x.

The re-sorting unit 356 then determines whether or not the parameter number x is equal to or smaller than the maximum value Mv (step S56). If the parameter number x is equal to or smaller than the maximum value Mv (Yes in step S56), the process returns to step S52, and if the parameter number x exceeds the maximum value Mv (No in step S56), the process ends.

According to the third embodiment as described above, parameters once identified as variable parameters in accordance with the classification flags are analyzed for their contribution to the evaluation values and re-sorted to fixed parameters when their contribution is low; therefore, the dimension of the variable parameters can be further reduced, and the optimal processing condition search is easily.

### Fourth Embodiment

In the first embodiment, the optimal-processing-condition search unit 132 gives feature candidates of multiple variable parameters generated through a predetermined method as input to a learning model, acquires predicted values of evaluation values obtained as a response of the learning model to the input, and outputs the candidate that gives the best predicted value among the predicted values as the optimal processing condition.

However, in the first search, only data regarding the processing performed in the past is stored in the processing-result-evaluation storage unit 123. In this case, rather than the processing condition predicted by the learning model, it may be better to select a processing condition in the past data that is similar in condition and known to have obtained a satisfactory evaluation value as the optimal processing condition.

Accordingly, the fourth embodiment describes an example of determining the optimal processing condition in the first search on the basis of first feature data, second feature data, third feature data, and evaluation values.

As illustrated in FIG. 1, a processing system 400 according to the fourth embodiment includes a processing machine 110 and a processing-condition search device 420.

The processing machine 110 of the processing system 400 according to the fourth embodiment is the same as the processing machine 110 of the processing system 100 according to the first embodiment.

As illustrated in FIG. 2, the processing-condition search device 420 according to the fourth embodiment includes a processing-result acquiring unit 121, a processing-result evaluating unit 122, a processing-result-evaluation storage unit 123, a classification-flag storage unit 124, a parameter classifying unit 125, a first dimensionality reducing unit 126, a second dimensionality reducing unit 127, a machine learning unit 128, a model storage unit 129, a fixed-parameter storage unit 130, a third dimensionality reducing unit 131, an optimal-processing-condition search unit 432, a dimensionality restoring unit 133, and a processing-condition instructing unit 134.

The processing-result acquiring unit 121, the processing-result evaluating unit 122, the processing-result-evaluation storage unit 123, the classification-flag storage unit 124, the parameter classifying unit 125, the first dimensionality reducing unit 126, the second dimensionality reducing unit 127, the machine learning unit 128, the model storage unit 129, the fixed-parameter storage unit 130, the third dimensionality reducing unit 131, the dimensionality restoring unit 133, and the processing-condition instructing unit 134 of the processing-condition search device 420 according to the fourth embodiment are respectively the same as the processing-result acquiring unit 121, the processing-result evaluating unit 122, the processing-result-evaluation storage unit 123, the classification-flag storage unit 124, the parameter classifying unit 125, the first dimensionality reducing unit 126, the second dimensionality reducing unit 127, the machine learning unit 128, the model storage unit 129, the fixed-parameter storage unit 130, the third dimensionality reducing unit 131, the dimensionality restoring unit 133, and the processing-condition instructing unit 134 of the processing-condition search device 120 according to the first embodiment.

Only in the first search, the optimal-processing-condition search unit 432 selects all processing numbers that satisfy a predetermined criterium from the multiple evaluation values included in the processing-result evaluation information stored in the processing-result-evaluation storage unit 123. The optimal-processing-condition search unit 432 then specifies second features corresponding to the selected processing numbers in the second feature data and specifies one processing number of which the specified second features are closest to third features represented by the third feature data. For example, it is sufficient to specify one processing number that minimizes the distance between features calculated using the distances between the second features and the third features.

The optimal-processing-condition search unit 432 then determines the feature corresponding to the specified processing number in the first feature data as the optimal processing condition and gives the determined optimal processing condition to the dimensionality restoring unit 133.

In searches other than the first search, the optimal-processing-condition search unit 432 determines the optimal processing condition in the same manner as in the first embodiment.

FIG. 13 is a flowchart illustrating an operation of the optimal-processing-condition search unit 432 during the first search.

The flowchart illustrated in FIG. 13 is performed only for the first search.

First, the optimal-processing-condition search unit 432 selects all processing numbers that satisfy a predetermined criterium from the multiple evaluation values included in the processing-result evaluation information stored in the processing-result-evaluation storage unit 123. For example, it is sufficient to use a predetermined threshold to select all processing numbers for which the processing results are determined to be better than the evaluation value corresponding to the threshold.

Next, the optimal-processing-condition search unit 432 specifies a processing number n* of a second feature that is closest to a third feature among the second features corresponding to the selected processing numbers (step S61).

Next, the optimal-processing-condition search unit 432 determines the features corresponding to the processing number n* in the first feature data as an optimal processing condition (step S62). The determined optimal processing condition is then given to the dimensionality restoring unit 133.

The third features are obtained by converting the values of parameters that are not allowed to be changed in a search into features; and by searching for the second features whose evaluation values are good and closest to the third features in the past data and selecting the corresponding variable parameters as a first optimal processing condition, it is expected that a good processing condition can be found in a small number of searches.

As described above, in the fourth embodiment, when an optimal value is retrieved for the first time, the optimal-processing-condition search unit 432 functions as a search unit that specifies one or more evaluation values out of multiple evaluation values that are higher than a predetermined evaluation value, one or more second features out of multiple second features that correspond to the specified one or more evaluation values, one second feature out of the specified second features that is closest to the third feature, specifies one first feature corresponding to the one second feature, and establishes the one first feature as the optimal value.

As described above, according to the fourth embodiment, in the first search, a condition that has a good processing result and values that are similar to the actual values of the fixed parameters that are not allowed to be changed in this search is retrieved from past processing conditions stored in the processing-result-evaluation storage unit 123, and corresponding variable parameters are established as the first optimal processing condition; in this way, a good processing condition can be found in a smaller number of searches.

The parameter classifying unit 125 according to the fourth embodiment is the same as the parameter classifying unit 125 according to the first embodiment, but the fourth embodiment is not limited to such an example. For example, the parameter classifying unit 125 according to the fourth embodiment may be the parameter classifying unit 225 according to the second embodiment or the parameter classifying unit 325 according to the third embodiment.

### Fifth Embodiment

In the first embodiment, the classified variable parameter data and fixed parameter data are separately subjected to dimensionality reduction. In the fifth embodiment, to enhance the reduction effect, the result of the dimensionality reduction of parameter data in a batch without classification is used as a reference, and each reduction process is adjusted to approximate this result.

As illustrated in FIG. 1, a processing system 500 according to the fifth embodiment includes a processing machine 110 and a processing-condition search device 520.

The processing machine 110 of the processing system 500 according to the fifth embodiment is the same as the processing machine 110 of the processing system 100 according to the first embodiment.

FIG. 14 is a block diagram schematically illustrating a configuration of the processing-condition search device 520.

The processing-condition search device 520 includes a processing-result acquiring unit 121, a processing-result evaluating unit 122, a processing-result-evaluation storage unit 123, a classification-flag storage unit 124, a parameter classifying unit 125, a first dimensionality reducing unit 526, a second dimensionality reducing unit 527, a machine learning unit 128, a model storage unit 129, a fixed-parameter storage unit 130, a third dimensionality reducing unit 131, an optimal-processing-condition search unit 132, a dimensionality restoring unit 133, a processing-condition instructing unit 134, a fourth dimensionality reducing unit 560, a first comparing unit 561, and a second comparing unit 562.

The processing-result acquiring unit 121, the processing-result evaluating unit 122, the processing-result-evaluation storage unit 123, the classification-flag storage unit 124, the parameter classifying unit 125, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 520 according to the fifth embodiment are respectively the same as the processing-result acquiring unit 121, the processing-result evaluating unit 122, the processing-result-evaluation storage unit 123, the classification-flag storage unit 124, the parameter classifying unit 125, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 120 according to the first embodiment.

The fourth dimensionality reducing unit. 560 is a dimensionality reducing unit that generates fourth features by reducing the dimensionality of multiple parameters.

For example, the fourth dimensionality reducing unit 560 reads a processing condition from the processing-result evaluation information stored in the processing-result-evaluation storage unit 123 and performs dimensionality reduction on the multiple parameters included in the read processing condition, to generate fourth feature data. The generated fourth feature data is given to the first comparing unit 561 and the second comparing unit 562.

The first dimensionality reducing unit 526 generates first feature data, as in the first embodiment, and gives the generated first feature data to the first comparing unit 561. However, the first dimensionality reducing unit 526 reduces the dimension of multiple variable parameters regardless of the dimension number of the variable parameters to generate first features.

The first dimensionality reducing unit 526 then acquires, from the first comparing unit 561, a first similarity score, which is a similarity score calculated by comparing the first feature data with the fourth feature data, and determines whether or not the first similarity score has converged.

If the first similarity score has not converged, the first dimensionality reducing unit 526 makes the adjustment by changing the dimensionality reduction process so as to increase the degree of similarity, which is represented by the first similarity score, between the first feature data and the fourth feature data. The first dimensionality reducing unit 526 then generates the first feature data again through the adjusted dimensionality reduction process and gives the generated first feature data to the first comparing unit 561.

The above process is repeated until the first similarity score converges.

When the first similarity score converges, the first dimensionality reducing unit 526 gives the first feature data determined to have converged to the machine learning unit 128. The first features before the first similarity score converges is also referred to as first tentative features.

As described above, the first dimensionality reducing unit 526 repeats the generation of the first tentative features by changing the process for reducing the dimension of the variable parameters until, the first similarity score converges and determines the first tentative features obtained when the first similarity score converges as the first features.

The second dimensionality reducing unit 527 generates the second feature data, as in the first embodiment, and gives the generated second feature data to the second comparing unit 562. However, the second dimensionality reducing unit 527 reduces the dimension of the fixed parameters regardless of the dimension number of the fixed parameters to generate the second features.

The second dimensionality reducing unit 527 then acquires, from the second comparing unit 562, a second similarity score, which is a similarity score calculated by comparing the second feature data with the fourth feature data, and determines whether or not the second similarity score has converged.

If the second similarity score has not converged, the second dimensionality reducing unit 527 makes the adjustment by changing the dimensionality reduction process so as to increase the degree of similarity, which is represented by the second similarity score, between the second feature data and the fourth feature data. The second dimensionality reducing unit 527 then generates the second feature data again through the adjusted dimensionality reduction process and gives the generated second feature data to the second comparing unit 562.

The above process is repeated until the second similarity score converges.

When the second similarity score converges, the second dimensionality reducing unit 527 gives the second feature data determined to have converged to the machine learning unit 128. The second features before the second similarity score converges is also referred to as second tentative features.

As described above, the second dimensionality reducing unit 527 repeats the generation of the second tentative features by changing the process for reducing the dimension of the fixed parameters until the second similarity score converges and determines the second tentative features obtained when the second similarity score converges as the second features.

The first comparing unit 561 calculates the first similarity score, which is a similarity score representing the degree of similarity between the first tentative features and the fourth features.

The second comparing unit 562 calculates the second similarity score, which is a similarity score representing the degree of similarity between the second tentative features and the fourth features.

Specific examples of the similarity score includes the absolute value of the correlation coefficient, cross-entropy, KL divergence, and other mutual information. For cross-entropy and mutual information, the more similar the data being compared is, the lower the value; thus, when these are used as the similarity score, the positive and negative signs should be reversed, or the score should be in the form of an inverse number.

An autoencoder is a suitable example of a dimensionality reduction process by the first dimensionality reducing unit 526, the second dimensionality reducing unit 527, and the fourth dimensionality reducing unit 560 of the fifth embodiment, and the first dimensionality reducing unit 526 and the second dimensionality reducing unit 527 can obtain a dimensionality reduction effect similar to that of the fourth dimensionality reducing unit 560 by adding the above cross-entropy or KL divergence to a loss function when the autoencoder is trained.

When the dimensions of the fourth feature data and the first or second feature data are different, for example, similarity scores may be calculated for all feature combinations, and the maximum or average value may be adopted as the first or second similarity score.

For example, Mv is the dimension number of the first feature data, and Mo is the dimension number of the fourth feature data. At this time, the similarity score α_{1[x,z]} between the features of the x-th dimension of the first feature data and the features of the z-th dimension of the fourth feature data is expressed by the following equation (6):

α_{1[x,z]}=Γ(Avₓ,Ao_{z}) (6)

Here, Γ is a function that calculates a similarity score.

Avₓ is a vector whose elements are av₁ₓ, av₂ₓ, . . . , av_{Nx}, where avₙₓ is a feature of the x-th dimension of the first feature data at a processing number n.

Moreover, Ao_{z} is a vector whose elements are ao_{1z}, ao_{2z}, . . . , ao_{Nx}, where a feature ao_{nz} of the z-th dimension of the fourth feature data at a processing number n.

Here, N is the maximum processing number.

Such a first similarity score α_{1(x,z)} is calculated for all combinations of x=1, 2, . . . , Mv and z=1, 2, . . . , Mo, and the maximum, minimum, or average value is used as the first similarity score α₁.

Similarly, for the second similarity score α₂, where a feature of the y-th dimension of the second feature data at a processing number n is af_{ny}, a similarity score α_{2(y,x)} expressed by the following equation (7) is calculated for all combinations of y=1, 2, . . . , Mf and z=1, 2, . . . , Mo by using a vector Af_{y} whose elements are af_{1y}, af_{2y}, . . . , af_{Ny}, and a vector Ao_{z} whose element is a feature in the z-th dimension of the fourth feature data, and the maximum, minimum, or average value is used as the second similarity score (2.

α_{2(y,z)}=Γ(Af_{y},Ao_{z}) (7)

If the amount of change from the previous similarity score is equal to or less than a predetermined threshold, the similarity score can be determined to have converged.

The hardware configuration of the processing-condition search device 520 according to the fifth embodiment described above is the same as the hardware configuration of the processing-condition search device 120 according to the first embodiment. For example, the fourth dimensionality reducing unit 560, the first comparing unit 561, and the second comparing unit 562 cart also be implemented by the processing circuitry 140.

FIG. 15 is a flowchart illustrating the operation of the first dimensionality reducing unit 526, the second dimensionality reducing unit 527, the fourth dimensionality reducing unit 560, the first comparing unit 561, and the second comparing unit 562 according to the fifth embodiment.

First, the fourth dimensionality reducing unit 560 reads a processing condition, i.e., parameters, included in the processing-result evaluation information stored in the processing-result-evaluation storage unit 123 and performs dimensionality reduction on the parameters to generate fourth feature data (step S70). The generated fourth feature data is given to the first comparing unit 561 and the second comparing unit 562.

The first dimensionality reducing unit 526 performs dimensionality reduction on the variable parameter data from the parameter classifying unit 125, as in the first embodiment, and generates first feature data (step S71). The first feature data is given to the first comparing unit 561.

The first comparing unit 561 compares the fourth feature data with the first feature data and calculates a first similarity score α₁ (step S73). The first similarity score co is given to the first dimensionality reducing unit 526.

The first dimensionality reducing unit 526 determines whether or not the first similarity score α₁ is converging (step S73). If the first similarity score α₁ is not converging (No in step S73), the process proceeds to step S74, and if the first similarity score α₁ is converging (Yes in step S73), the process proceeds to step S75. Here, the first dimensionality reducing unit 526 gives the first feature data generated in step S71 to the machine learning unit 128.

In step S74, the first dimensionality reducing unit 526 changes the dimensionality reduction process so that the first similarity score α₁ increases. The process then returns to step S71.

In step S75, the second dimensionality reducing unit 527 performs dimensionality reduction on the fixed parameter data from the parameter classifying unit 125, as in the first embodiment, and generates second feature data (step S72). The second feature data is given to the second comparing unit 562.

The second comparing unit 562 compares the fourth feature data with the second feature data and calculates a second similarity score α₂ (step S76), The second similarity score α2 is given to the second dimensionality reducing unit 527.

The second dimensionality reducing unit 527 determines whether or not the second similarity score ar is converging (step S77). If the second similarity score α2 is not converging (No in step S77), the process proceeds to step S78, and if the second similarity score α2 is converging (Yes in step S77), the second dimensionality reducing unit. 527 gives the second feature data generated in step S75 to the machine learning unit 128; and then the process ends.

In step S78, the second dimensionality reducing unit 527 changes the dimensionality reduction process so that the second similarity score α₂ increases. The process then returns to step S75.

As described above, according to the fifth embodiment, when dimensionality reduction is performed on the classified variable parameter data and fixed parameter data, the result of the dimensionality reduction of parameter data in a batch without classification is used as a reference, and each reduction process is adjusted to approximate this result, so that the dimensionality reduction effect can be enhanced.

The parameter classifying unit 125 according to the fifth embodiment is the same as the parameter classifying unit 125 according to the first embodiment, but the fifth embodiment is not limited to such an example. For example, the parameter classifying unit 125 according to the fifth embodiment may be the parameter classifying unit 225 according to the second embodiment or the parameter classifying unit 325 according to the third embodiment.

The optimal-processing-condition search unit 132 according to the fifth embodiment may also be the optimal-processing-condition search unit 432 according to the fourth embodiment.

### Sixth Embodiment

In the fifth embodiment, the first features and the second features are individually compared with the fourth features. In the sixth embodiment, the first features and the second features are combined so as to have the same dimension number as that of the fourth feature and are then compared with the fourth features.

As illustrated in FIG. 1, a processing system 600 according to the sixth embodiment includes a processing machine 110 and a processing-condition search device 620.

The processing machine 110 of the processing system 600 according to the sixth embodiment is the same as the processing machine 110 of the processing system 100 according to the first embodiment.

FIG. 16 is a block diagram schematically illustrating a configuration of the processing-condition search device 620.

The processing-condition search device 620 includes a processing-result acquiring unit 121, a processing-result evaluating unit 122, a processing-result-evaluation storage unit 123, a classification-flag storage unit 124, a parameter classifying unit 125, a first dimensionality reducing unit 626, a second dimensionality reducing unit 627, a machine learning unit 128, a model storage unit 129, a fixed-parameter storage unit 130, a third dimensionality reducing unit 131, an optimal-processing-condition search unit 132, a dimensionality restoring unit 133, a processing-condition instructing unit 134, a fourth dimensionality reducing unit 560, a combining unit 663, and a comparing unit 664.

The processing-result acquiring unit 121, the processing-result evaluating unit 122, the processing-result-evaluation storage unit 123, the classification-flag storage unit 124, the parameter classifying unit 125, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 620 according to sixth embodiment are respectively the same as the processing-result acquiring unit 121, the processing-result evaluating unit 122, the processing-result-evaluation storage unit 123, the classification-flag storage unit 124, the parameter classifying unit 125, the machine learning unit 128, the model storage unit 129, the fixed-parameter storage unit 130, the third dimensionality reducing unit 131, the optimal-processing-condition search unit 132, the dimensionality restoring unit 133, and the processing-condition instructing unit 134 of the processing-condition search device 120 according to the first embodiment.

The fourth dimensionality reducing unit 560 of the processing-condition search device 620 according to the sixth embodiment is the same as the fourth dimensionality reducing unit 560 of the processing-condition search device 520 according to the fifth embodiment. However, in the sixth embodiment, the fourth dimensionality reducing unit 560 gives the generated fourth feature data to a comparing unit 664.

The first dimensionality reducing unit 626 generates first feature data, as in the first embodiment, and gives the generated first feature data to the combining unit 663. However, the first dimensionality reducing unit 626 reduces the dimension of the variable parameters regardless of the dimension number of variable parameters, to generate first features.

The first dimensionality reducing unit 626 then acquires, from the comparing unit 664, a similarity score calculated by comparing combined feature data representing combined features of the first feature data and the second feature data with the fourth feature data, and determines whether or not the similarity score has converged.

If the similarity score has not converged, the first dimensionality reducing unit 626 makes the adjustment by changing the dimensionality reduction process so as to increase the degree of similarity, which is represented by the similarity score, between the combined feature data and the fourth feature data. The first dimensionality reducing unit 626 then generates the first feature data again through the adjusted dimensionality reduction process and gives the generated first feature data to the combining unit 663.

The above process is repeated until the similarity score converges.

When the similarity score converges, the first dimensionality reducing unit 626 gives the first feature data determined to have converged to the machine learning unit 128. The first features before the first similarity score converges is also referred to as first tentative features.

As described above, the first dimensionality reducing unit 626 repeats the generation of the first tentative features by changing the process for reducing the dimension of the variable parameters until the similarity score converges and determines the first tentative features obtained when the similarity score converges as the first features.

The second dimensionality reducing unit 627 generates second feature data, as in the first embodiment, and gives the generated second feature data to the combining unit 663. However, the second dimensionality reducing unit 627 reduces the dimension of the fixed parameters regardless of the dimension number of the fixed parameters to generate the second features.

The second dimensionality reducing unit 627 then acquires, from the comparing unit 664, a similarity score calculated by comparing combined feature data representing combined features of the first feature data and the second feature data with the fourth feature data, and determines whether or not the similarity score has converged.

If the second similarity score has not converged, the second dimensionality reducing unit 627 makes adjustment the convergence by changing the dimensionality reduction process so as to increase the degree of similarity, which is represented by the similarity score, between the combined feature data and the fourth feature data. The second dimensionality reducing unit 627 then generates the second feature data again through the adjusted dimensionality reduction process and gives the generated second feature data to the combining unit 663.

The above process is repeated until the similarity score converges.

When the second similarity score converges, the second dimensionality reducing unit 627 gives the second feature data determined to have converged to the machine learning unit 128. The second features before the second similarity score converges is also referred to as second tentative features.

As described above, the second dimensionality reducing unit 627 repeats the generation of the second tentative features by changing the process for reducing the dimension of the fixed parameters until the similarity score converges and determines the second tentative features obtained when the similarity score converges as the second features.

The combining unit 663 combines the first tentative features and the second tentative features to generate combined features, and makes the dimension of the combined features to be the same as the dimension of the fourth features.

For example, the combining unit 663 combines the first features represented by the first feature data received from the first dimensionality reducing unit 626 with the second features represented by the second feature data output from the second dimensionality reducing unit 627 so that the dimension number of the combined features is the same as the dimension of the fourth features, and generates combined feature data representing the combined features. The generated combined feature data is given to the comparing unit 664.

Specifically, if the feature combining means is, for example, linear combination, the combining unit 663 can perform combination in accordance with the following equation (8), where as_{nz} is an element of the z-th dimension of a combined feature of a processing number n:

$${as}_{nz} = {\sum }_{k = 1}^{Mv} {wv}_{k} {av}_{nk} + {\sum }_{k = 1}^{Mf} {wf}_{k} {af}_{nk} \qquad ( 8 )$$

Here, wvₖ and wfₖ are weighting factors.

Another example of the combining means is a neural network. In this case, as_{nz} is the output of the neural network when avₙₓ is input for x=1, 2, . . . , Mv and af_{ny} is input for y=1, 2, . . . , Mf.

The combining unit 663 then acquires, from the comparing unit 664, a similarity score calculated by comparing combined feature data representing combined features of the first feature data and the second feature data with the fourth feature data, and determines whether or not the similarity score has converged.

If the similarity score has not converged, the combining unit 663 makes the adjustment by changing the combination process so as to increase the degree of similarity, which is represented by the similarity score, between the combined feature data and the fourth feature data.

In other words, the combining unit 663 changes the process of combining first tentative features and second tentative features until the similarity score converges.

The comparing unit 664 calculates a similarity score representing the degree of similarity between the combined features and the fourth features.

For example, the comparing unit 664 compares the fourth feature data with the combined feature data received from the combining unit 663 and calculates a similarity score α.

Specific examples of the similarity score includes the absolute value of the correlation coefficient, cross-entropy, KL Divergence, and other mutual information. For cross-entropy and mutual information, the more similar the data being compared is, the lower the value; thus, when these are used as the similarity score, the positive and negative signs should be reversed, or the score should be in the form of an inverse number.

An autoencoder is a suitable example of a dimensionality reduction process by the first dimensionality reducing unit 626, the second dimensionality reducing unit 627, and the fourth dimensionality reducing unit 660 of the sixth embodiment, and the first dimensionality reducing unit 626 and the second dimensionality reducing unit 627 can obtain a dimensionality reduction effect similar to that of the fourth dimensionality reducing unit 660 by adding the above cross-entropy or KL information content to a loss function when the autoencoder is trained.

If the amount of change from the previous similarity score is equal to or less than a predetermined threshold, the similarity score can be determined to have converged.

The hardware configuration of the processing-condition search device 620 according to the sixth embodiment described above is the same as the hardware configuration of the processing-condition search device 120 according to the first embodiment. For example, the fourth dimensionality reducing unit-66G 660, the combining unit 663, and the comparing unit 664 can also be implemented by the processing circuitry 140.

FIG. 17 is a flowchart illustrating the operation of the first dimensionality reducing unit 626, the second dimensionality reducing unit 627, the fourth dimensionality reducing unit 660, the combining unit 663, and the comparing unit 664 according to the sixth embodiment.

First, the fourth dimensionality reducing unit 560 reads a processing condition, i.e., parameters, included in the processing-result evaluation information stored in the processing-result-evaluation storage unit 123 and performs dimensionality reduction on the parameters to generate fourth feature data (step S80). The generated fourth feature data is given to the comparing unit 664.

The first dimensionality reducing unit 626 performs dimensionality reduction on the variable parameter data from the parameter classifying unit 125, as in the first embodiment, and generates first feature data (step S81). The first feature data is given to the combining unit 663.

The second dimensionality reducing unit 627 performs dimensionality reduction on the fixed parameter data from the parameter classifying unit 125, as in the first embodiment, and generates second feature data (step S82). The second feature data is given to the combining unit 663.

The combining unit 663 combines the first features represented by the first feature data received from the first dimensionality reducing unit 626 with the second features represented by the second feature data output from the second dimensionality reducing unit 627 so that the dimension number of the combined features is the same as the dimension of the fourth features, and generates combined feature data representing the combined features (step S83). The generated combined feature data is given to the comparing unit 664.

The comparing unit 664 compares the fourth feature data with the combined feature data and calculates a similarity score α (step S84). The similarity score α is given to the first dimensionality reducing unit 626, the second dimensionality reducing unit 627, and the combining unit 663.

The first dimensionality reducing unit 626, the second dimensionality reducing unit 627, and the combining unit 663 determine whether or not the similarity score α is converging (step S85). If the similarity score α is not converging (No in step S85), the process proceeds to step S86. If the similarity score α is converging (Yes in step S85), the first dimensionality reducing unit 626 gives the first feature data generated in step S81 to the machine learning unit 128, the second dimensionality reducing unit 627 gives the second feature data generated in step S82 to the machine learning unit 128, and then the process ends.

In step S86, the first dimensionality reducing unit 626 and the second dimensionality reducing unit 627 change the dimensionality reduction process so that the similarity score α increases.

Next, the combining unit 663 changes the combining process so that the similarity score α increases (step S87). The process then returns to step S81.

As described above, according to the sixth embodiment, when the dimensionality reduction of classified variable parameter data and fixed parameter data is adjusted with reference to a result of dimensionality reduction of parameter data in a batch without classification, the features of the variable parameter data and the features of the fixed parameter data are combined so that their dimension number is the same as the dimension number of the features acquired as a result of dimensionality reduction of parameter data in a batch without classification, and compared to acquire a similarity score; therefore, a reduction effect more similar to that of dimensionality reduction of parameter data in a batch without classification can be achieved.

The parameter classifying unit 125 according to the sixth embodiment is the same as the parameter classifying unit 125 according to the first embodiment, but the sixth embodiment is not limited to such an example. For example, the parameter classifying unit 125 according to the sixth embodiment may be the parameter classifying unit 225 according to the second embodiment or the parameter classifying unit 325 according to the third embodiment.

The optimal-processing-condition search unit 132 according to the sixth embodiment may also be the optimal-processing-condition search unit 432 according to the fourth embodiment.

What is claimed is:

1. A processing-condition search device comprising: processing circuitry
to store processing-result evaluation information representing a plurality of processing conditions each having a plurality of parameters and a plurality of evaluation values of a plurality of processing results under the processing conditions;
to classify the plurality of parameters into a plurality of variable parameters allowing change and one or more fixed parameters not allowing change;
to generate one or more first features corresponding to the processing conditions by generating the first features with a dimension equal to or smaller than a first dimension from the variable parameters, the first dimension being a predetermined dimension;
to generate one or more second features corresponding to the processing conditions by generating the second features with a dimension equal to or smaller than a second dimension from the one or more fixed parameters, the second dimension being a predetermined dimension;
to generate a learning model by learning a relationship between the one or more first features, the one or more second features, and the evaluation values;
to generate a third feature with a dimension equal to or smaller than the second dimension from one or more target fixed parameters, the one or more target fixed parameters being one or more fixed parameters used under a target processing condition, the target processing condition being a processing condition to be retrieved;
to search for an optimal value of a feature of a plurality of target variable parameters by using the third feature and the learning model, the target variable parameters being a plurality of variable parameters used under the target processing condition; and
to specify a retrieved processing condition from the optimal value and the one or more target fixed parameters, the retrieved processing condition being a processing condition retrieved as the target processing condition.

2. The processing-condition search device according to claim 1, wherein the processing circuitry is configured to generate the first features by reducing the dimension of the variable parameters when the dimension of the variable parameters is larger than the first dimension.

3. The processing-condition search device according to claim 1, wherein the processing circuitry is configured to generate the second features by reducing the dimension of the fixed parameters when the dimension of the fixed parameters is larger than the second dimension.

4. The processing-condition search device according to claim 1, wherein the processing circuitry is configured to generate the third feature by reducing the dimension of the target fixed parameters when the dimension of the target fixed parameters is larger than the second dimension.

5. The processing-condition search device according to claim 1, wherein when the dimension of the variable parameters is larger than the first dimension, the processing circuitry is configured to restore a plurality of parameters from the optimal value in such a manner that the dimension of the plurality of parameters is the same as the dimension of the variable parameters.

6. The processing-condition search device according to claim 1, wherein, the processing circuitry is configured
to generate first tentative features by reducing the dimension of the variable parameters,
to generate second tentative features by reducing the dimension of the fixed parameters,
to generate fourth features by reducing the dimension of the plurality of parameters,
to calculate a first similarity score representing a degree of similarity between the first tentative features and the fourth features,
to calculate a second similarity score representing a degree of similarity between the second tentative features and the fourth features,
to repeat the generation of the first tentative features by changing the process of reducing the dimension of the variable parameters until the first similarity score converges, and to establish the first tentative features obtained when the first similarity score converges as the first features, and
to repeat the generation of the second tentative features by changing the process of reducing the dimension of the fixed parameters until the second similarity score converges, and establishes the second tentative features obtained when the second similarity score converges as the second features.

7. The processing-condition search device according to claim 1, wherein, the processing circuitry is configured
to generate first tentative features by reducing the dimension of the variable parameters,
to generate second tentative features by reducing the dimension of the fixed parameters,
to generate fourth features by reducing the dimension of the plurality of parameters,
to generate combined features by combining the first tentative features with the second tentative features and making the dimension of the combined features the same as the dimension of the fourth features,
to calculate a similarity score representing a degree of similarity between the combined features and the fourth features,
to repeat the generation of the first tentative features by changing the process of reducing the dimension of the variable parameters until the similarity score converges, and to establish the first tentative features obtained when the similarity score converges as the first features,
to repeat the generation of the second tentative features by changing the process of reducing the dimension of the fixed parameters until the similarity score converges, and to establish the second tentative features obtained when the similarity score converges as the second features, and
to change the process of combining the first tentative features and the second tentative features until the similarity score converges.

8. The processing-condition search device according to claim 6, wherein the processing circuitry is configured to restore parameters from the optimal value in such a manner that the dimension of the parameters is the same as the dimension of the variable parameters.

9. The processing-condition search device according to claim 1, wherein the processing circuitry is configured
to store a classification flag representing whether the plurality of parameters are variable parameters or fixed parameters for each type, in order to classify the plurality of parameters, and
to refer to the classification flags to classifies the plurality of parameters into the variable parameters and the one or more fixed parameters.

10. The processing-condition search device according to claim 1, wherein the processing circuitry is configured
to store a classification flag representing whether the plurality of parameters are variable parameters or fixed parameters for each type, in order to classify the plurality of parameters,
to refer to the classification flags to sort the plurality of parameters into a plurality of initial variable parameters and one or more initial fixed parameters,
to specify a plurality of combinations of the initial variable parameters and the one or more initial fixed parameters and analyze the correlation of each of the combinations-, and
to re-sort initial variable parameters included in the combinations of which the correlation is higher than a predetermined threshold to initial fixed parameters, to establish the re-sorted initial variable parameters as the variable parameters and establish the re-sorted one or more initial fixed parameters as the one or more fixed parameters.

11. The processing-condition search device according to claim 1, wherein the processing circuitry is configured
to store a classification flag representing whether the plurality of parameters are variable parameters or fixed parameters for each type, in order to classify the plurality of parameters,
to refer to the classification flags to sort the plurality of parameters into a plurality of initial variable parameters and one or more initial fixed parameters,
to analyze the contribution of the initial variable parameters to the evaluation values, and
to re-sort the initial variable parameters of which the contribution is equal to or lower than a predetermined threshold to initial fixed parameter, to establish the re-sorted initial variable parameters as the variable parameters and establish the re-sorted one or more initial fixed parameters as the one or more fixed parameters.

12. The processing-condition search device according to claim 1, wherein the processing circuitry is configured
to give the retrieved processing condition to a processing machine to cause the processing machine to perform processing under the retrieved processing condition, and add the retrieved processing condition to the processing-result evaluation information, and
to determine an evaluation value by evaluating a processing result and adding the evaluation value determined in association with the retrieved processing condition to the processing-result evaluation information, the processing result being a result of processing performed by the processing machine, wherein
when the optimal value is retrieved for a first time, processing circuitry is configured to specify one or more evaluation values evaluated to be higher than a predetermined evaluation out of a plurality of the evaluation values, to specify one or more second features corresponding to the one or more evaluation values out of a plurality of the second features, to specify one second feature closest to the third feature out of the second features, to specify one first feature corresponding to the one second feature, and to establish the one first feature as the optimal value.

13. A non-transitory computer-readable medium that stores therein a program that causes a computer to-execute processes of:
storing processing-result evaluation information representing a plurality of processing conditions each having a plurality of parameters and a plurality of evaluation values of a plurality of processing results under the processing conditions;
classifying the plurality of parameters into a plurality of variable parameters allowing change and one or more fixed parameters not allowing change;
generating one or more first features corresponding to the processing conditions by generating the first features with a dimension equal to or smaller than a first dimension from the variable parameters, the first dimension being a predetermined dimension;
generating one or more second features corresponding to the processing conditions by generating the second features with a dimension equal to or smaller than a second dimension from the one or more fixed parameters, the second dimension being a predetermined dimension;
generating a learning model by learning a relationship between the one or more first features, the one or more second features, and the evaluation values;
generating a third feature with a dimension equal to or smaller than the second dimension from one or more target fixed parameters, the one or more target fixed parameters being one or more fixed parameters used under a target processing condition, the target processing condition being a processing condition to be retrieved;
searching for an optimal value of a feature of a plurality of target variable parameters by using the third feature and the learning model, the target variable parameters being a plurality of variable parameters used under the target processing condition; and
specifying a retrieved processing condition from the optimal value and the one or more target fixed parameters, the retrieved processing condition being a processing condition retrieved as the target processing condition.

14. A processing-condition search method comprising:
classifying a plurality of parameters into a plurality of variable parameters allowing change and one or more fixed parameters not allowing change, the variable parameters being included in processing-result evaluation information representing a plurality of processing conditions each having the parameters and a plurality of evaluation values of a plurality of processing results under the processing conditions;
generating one or more first features corresponding to the processing conditions by generating the first features with a dimension equal to or smaller than a first dimension from the variable parameters, the first dimension being a predetermined dimension;
generating one or more second features corresponding to the processing conditions by generating the second features with a dimension equal to or smaller than a second dimension from the one or more fixed parameters, the second dimension being a predetermined dimension;
generating a learning model by learning a relationship between the one or more first features, the one or more second features, and the evaluation values;
generating a third feature from one or more target fixed parameters, the third feature having a dimension equal to or lower than the second dimension, the one of more target fixed parameters being one or more fixed parameters used under a target processing condition, the target processing condition being a processing condition to be retrieved;
searching for an optimal value of features of a plurality of target variable parameters by using the third feature and the learning model, the target variable parameters being a plurality of variable parameters used under the target processing condition; and
specifying a retrieved processing condition from the optimal value and the one or more target fixed parameters, the retrieved processing condition being a processing condition retrieved as the target processing condition.
